(19) United States
(12) Patent Application Publication
(10) Pub. No.: US 2012/0087418 A1
(43) Pub. Date: Apr. 12, 2012

(54) Communication Device and Method of Determining a Ranging Value in the Communication Device

(75) Inventors: Yuanjin Zheng, Singapore (SG); Annamalai Arasu Muthukumaraswamy, Singapore (SG); King-Wah Wong, Singapore (FR); Yen Ju The, Singapore (SG)

(73) Assignee: AGENCY FOR SCIENCE, TECHNOLOGY AND RESEARCH, Singapore (SG)

(21) Appl. No.: 12/863,268

(22) PCT Filed: Jan. 14, 2009
(86) PCT No.: PCT/SG2009/000025

§ 371 Date: May 16, 2011

Related U.S. Application Data
(60) Provisional application No. 61/021,986, filed on Jan. 18, 2008.

(51) Int. Cl. H04L 27/00

(52) U.S. Cl. 375/259

(57) ABSTRACT

A communication device and a method of determining a ranging value in the communication device are provided. The communication device, includes: a transmitter path, including: a transmitter clock generating circuit configured to generate a transmitter clock signal; a receiver path, including: a clock recovery circuit configured to recover a receiver clock signal from a received signal; a comparator circuit coupled to the clock recovery circuit and configured to compare the receiver clock signal and the transmitter clock signal to generate an output signal; a ranging determination circuit configured to determine a ranging value based on the output signal.

### TECHNICAL FIELD

Embodiments relate generally to a communication device and a method of determining a ranging value in the communication device.

### BACKGROUND

Ultra wideband (UWB) technique has opened up a great potential for low-cost high-quality broadband multimedia applications, especially for wireless personal area networking applications. Specifically, UWB characterizes transmission systems with instantaneous spectral occupation in excess of 500 MHz or a fractional bandwidth of more than 20%. The bandwidth and spectral mask for indoor communication systems assigned by Federal Communications Commission (FCC) is in the frequency range of 3.1-10.6 GHz with power spectral density (PSD)<−41.3 dBm. This allows UWB technology to coexist with legacy services such as IEEE 802.11a wireless local area network (WLAN), radar systems, and to overlay with sensitive military and civilian services in adjacent bands such as global positioning system (GPS) and federal aviation system (FAS). However, cellular phones, for example, transmit up to +30 dBm, whose PSD is about 10⁷ times higher than what UWB transmitters are permitted. This requires the UWB system to have strong capability to resist the narrowband interference.

Impulse Radio is one spectrum spreading technique. It works by transmitting baseband pulses of very short duration, typically on the order of nanosecond or sub-nanosecond, thereby spreading the energy of the radio signal to a few Gigahertz range. The shape of the pulse specifies the frequency spectrum of the transmitted signal. A well-designed pulse shape allows maximum emitted power within the FCC allocated frequency mask. The spread spectrum ensures that it can tolerate the interference of other signals and at the same time, it does not cause interference to other radio systems working in their dedicated bands. Since UWB impulse radio occupies wide bandwidth and has very good time-domain resolution, it can be used for low duty cycle communication and precision localization etc. applications. While UWB impulse radio technique has been used for low rate low power communication, there is no report on a ranging/localization transceiver integrated circuit (IC) implementation using UWB impulse radio technique.

### SUMMARY

In an embodiment, there is provided a communication device, including: a transmitter path which includes: a transmitter clock generating circuit configured to generate a transmitter clock signal; and a receiver path which includes: a clock recovery circuit configured to recover a receiver clock signal from a received signal, a comparator circuit coupled to the clock recovery circuit and configured to compare the receiver clock signal and the transmitter clock signal to generate an output signal, and a ranging determination circuit configured to determine a ranging value based on the output signal.

In another embodiment, there is provided a method of determining a ranging value in a communication device, the method including: generating a transmitter clock signal; recovering a receiver clock signal from a received signal; comparing the receiver clock signal and the transmitter clock signal to generate an output signal; and determining the ranging value based on the output signal.

In another embodiment, there is provided a communication device, including: a clock recovery circuit configured to recover a receiver clock signal from a received radio preamble signal comprising a preamble code; and a ranging determination circuit configured to determine a ranging value based on the preamble signal.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1(a) shows a plot of a detailed channel distribution according to an embodiment.

FIG. 1(b) shows a structure of a BPM-BPSK (burst position modulation-binary phase shift keying) PHY symbol according to an embodiment.

FIG. 2 shows a schematic diagram of a communication device according to an embodiment.

FIG. 3 shows a flowchart of a process for determining a ranging value in the communication device according to an embodiment.

FIG. 4 shows data flow of the communication device at a system level according to an embodiment.

FIG. 5(a) shows a schematic diagram of a pulse shaper and a modulator of a transmitter according to an embodiment.

FIG. 5(b) shows a pole-zero map with an imaginary axis plotted against a real axis of the pulse shaper and the modulator according to an embodiment.

FIG. 5(c) shows a graph of attenuation plotted against frequency of the pulse shaper and the modulator according to an embodiment.

FIG. 6 shows a schematic diagram of a mixer of the transmitter according to an embodiment.

FIG. 7 shows a schematic diagram of an amplifier of the transmitter according to an embodiment.

FIG. 8(a) shows a schematic diagram of an amplifier and a mixer of a receiver according to an embodiment.

FIG. 8(b) shows a schematic diagram of a first stage circuit of the amplifier according to an embodiment.

FIG. 8(c) shows a schematic diagram of a second stage circuit of the amplifier according to an embodiment.

FIG. 9(a) shows a schematic diagram of an automatic offset cancellation circuit of a variable gain amplifier according to an embodiment.

FIG. 9(b) shows a schematic diagram of an amplifier circuit of the variable gain amplifier according to an embodiment.

FIG. 10 shows a schematic diagram of a frequency generator according to an embodiment.

FIG. 11 shows a schematic diagram of a quadrature voltage-controlled oscillator (QVCO) according to an embodiment.

FIG. 12(a) shows a schematic diagram of a coarse tuning control circuit for a first bit according to an embodiment.

FIG. 12(b) shows a schematic diagram of a coarse tuning control circuit for a second bit according to an embodiment.

FIG. 12(c) shows a schematic diagram of a coarse tuning control circuit for a third bit according to an embodiment.

FIG. 13(a) shows a schematic diagram of a ring oscillator of the QVCO according to an embodiment.

FIG. 13(b) shows a schematic diagram of a delay cell of the ring oscillator according to an embodiment.

FIG. 14 shows a schematic diagram of a frequency doubler of the QVCO according to an embodiment.

FIG. 15 shows a chip microphotograph of an example communication device according to an embodiment.

FIG. 16 shows a measured pulse sequence at an output of the transmitter according to an embodiment.

FIG. 17 shows a measured pulse sequence and a spectrum at channel 3 of the transmitter according to an embodiment.

FIG. 18 shows a measured pulse sequence and a spectrum at channel 9 of the transmitter according to an embodiment.

FIG. 19 shows measured RF front-end performance of the receiver at 5 GHz according to an embodiment.

FIG. 20 shows measured performance of the frequency generator according to an embodiment.

FIG. 21 shows measured localization performance of the communication device according to an embodiment.

FIG. 22 shows measured binary phase shift keying (BPSK) demodulation of the communication device at pulse repetition frequency (PRF) of 31.2 MHz and local oscillation (LO) of 4.49 GHz according to an embodiment.

FIG. 23 shows measured BPSK demodulation of the communication device at PRF of 31.2 MHz and LO of 7.98 GHz according to an embodiment.

FIG. 24 shows a table listing the performance of the communication device according to an embodiment.

### DETAILED DESCRIPTION

Exemplary embodiments of a communication device and a method of determining a ranging value in the communication device are described in detail below with reference to the accompanying figures. It will be appreciated that the exemplary embodiments described below can be modified in various aspects without changing the essence of the invention.

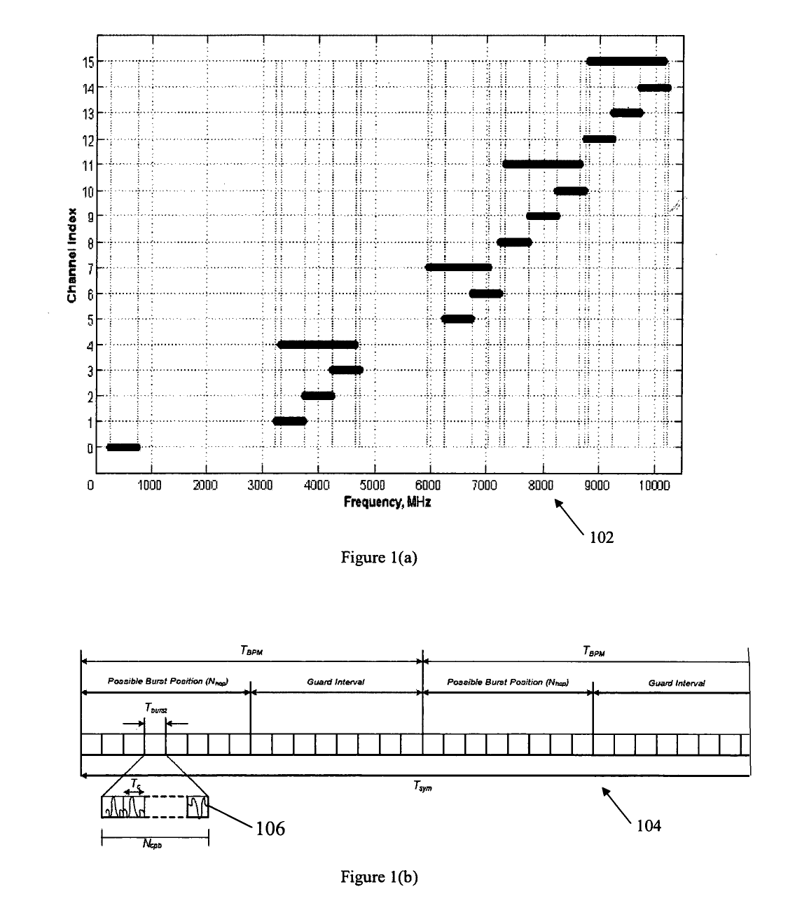

IEEE 802.15.4a has specified a UWB PHY for low rate commutation with ranging capability for wireless personnel area and sensor network applications. IEEE 802.15.4a supports three bands of operation, i.e. sub-1 GHz band (249.6-749.6 MHz), low band (3.1-4.8 GHz) and high band (6.0-10.6 GHz) with 16 channels in total. FIG. 1(a) shows a plot 102 of a detailed channel distribution. There are three compulsory channels with central frequencies of 499.2 MHz, 4492.8 MHz and 7987.2 MHz, while others are optional.

A combination of the burst position modulation (BPM) and binary phase shift keying (BPSK) can be used to support both coherent and non-coherent receivers using a common signaling scheme. The combined BPM-BPSK can be used to modulate the symbols, with each symbol being composed of a burst of UWB pulses. The various data rates can be supported through the use of variable-length bursts. FIG. 1(b) shows a structure of a BPM-BPSK PHY symbol 104. A symbol 104 can be capable of carrying two bits of information: one bit is used to determine the position of a burst of pulses while an additional bit is used to modulate the phase (polarity) of the same burst. Each symbol 104 can have an integer number of possible chip positions Nc, each with duration Tc. The overall symbol duration Tsym can be divided into two BPM intervals each with a duration Tbpm=Tsym/2 which enables binary position modulation. A burst 106 can be formed by grouping Ncpb consecutive chips and has a duration Tburst=NcpbTc. The localization of the burst in either the first half or the second half of the symbol 104 can indicate one bit of information. Additionally, the phase of the burst 106 (either −1 or 1) can be used to indicate a second bit of information.

With different coding rate, bursts per symbol, and chips per burst, the mean pulse repetition rate (PRF) can vary from 3.9 MHz to 62.4 MHz for data throughput of 120 kHz to 31.2 MHz. The transmitted spectrum can be defined as less than −10 dBr for 0.65/Tp<|f−fc|<0.8/Tp, and −18 dBr for |f−fc|>0.8/Tp. The measurements can be made using 1 MHz resolution bandwidth and a 1 KHz video bandwidth.

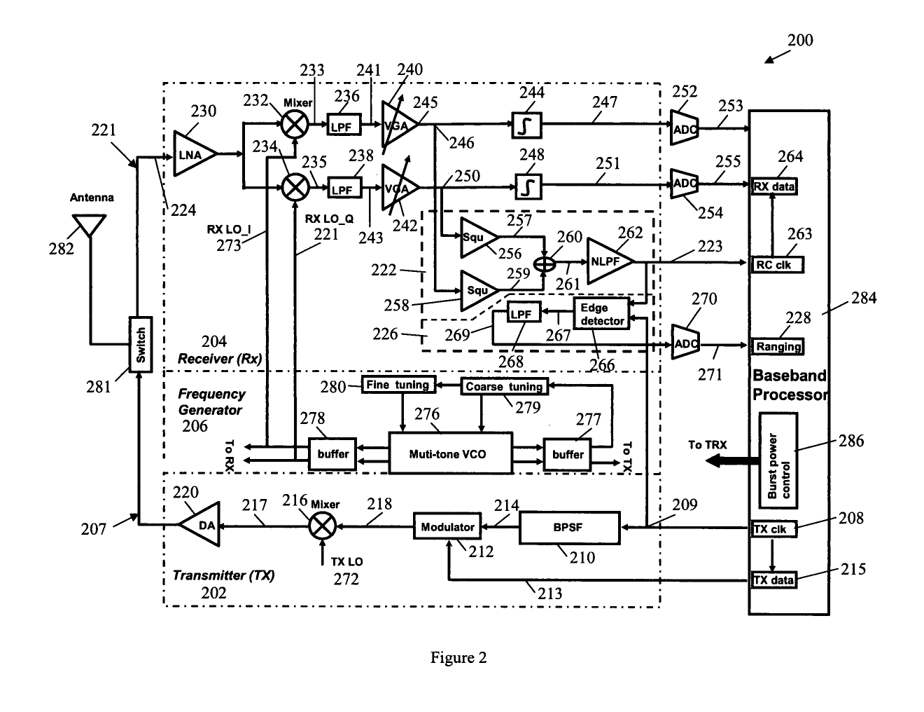

FIG. 2 shows a schematic diagram of an embodiment of a communication device 200 (e.g. UWB radio frequency (RF) transceiver). The communication device 200 may support a plurality of channels (e.g. 12 channels), variable date rate and ranging capability as specified in IEEE 802.15.4a. The communication device 200 may be IEEE 802.15.4a compliant and may support both communication and localization. Targeted for low cost, the communication device 200 may be implemented in a 0.18-μm complementary metal oxide semiconductor (CMOS) process. The communication device 200 may achieve scalable data rate communication (100K-1 Gbps), precision ranging (−3 cm resolution), and low power consumption (transmitter TX 0.77 nJ/pulse, receiver RX 5.51 nJ/pulse) through the optimized design of transceiver circuits. The communication device 200 may achieve comparable energy efficiency while it is targeted to be low cost (e.g. small die size in non-expensive process) and standard compliant. To further improve the performance of the communication device 200, a more advanced technology such as 90 nm and beyond can be considered especially for high frequency band.

The communication device 200 may include a transmitter 202, a receiver 204 and a frequency generator 206. The communication device 200 may include a transmitter path 207 for the transmitter 202. The transmitter path 207 may include a transmitter clock generating circuit 208 configured to generate a transmitter clock signal 209. The transmitter path 207 may include a pulse shaper 210 coupled to the transmitter clock generating circuit 208. The pulse shaper 210 may tunably shape the pulse of the transmitter clock signal 209. The pulse shaper 210 may be a baseband pulse shaping filter (BPSF).

The transmitter path 207 may include a modulator 212 coupled to the pulse shaper 210 to modulate a transmitter signal 213 to be transmitted into a plurality of predefined frequency ranges, triggered by the shaped transmitter clock signal 214. The predefined frequency ranges may be in the range of about 200 MHz to about 11 GHz. The transmitter signal 213 may be generated by a transmitter signal generating circuit 215. The transmitter signal 213 may be binary data. The transmitter signal generating circuit 215 may be coupled to the transmitter clock generating circuit 208 and the modulator 212.

The transmitter path 207 may include a mixer 216 to provide an up-converted signal 217 to be transmitted. The mixer 216 may be coupled to the modulator 212 to receive the modulated signal 218 to be transmitted. The transmitter path 207 may also include at least one amplifier 220 to amplify the up-converted signal 217 to be transmitted. The amplifier 220 may be a driver amplifier.

The communication device 200 may include a receiver path 221 for the receiver 204. The receiver path 221 may include a clock recovery circuit 222 configured to recover a receiver clock signal 223 from a received signal 224. The receiver path 221 may include a comparator circuit 226 coupled to the clock recovery circuit 222 and configured to compare the receiver clock signal 223 and the transmitter clock signal 209 to generate an output signal. The receiver path 221 may also include a ranging determination circuit 228 configured to determine a ranging value based on the output signal.

The receiver path 221 may include at least one amplifier 230 to amplify the received signal 224. The amplifier 230 may be a low noise amplifier. The receiver path 221 may also include an in-phase mixer 232 to provide an in-phase amplified signal 233 and a quadrature mixer 234 to provide a quadrature amplified signal 235. The in-phase mixer 232 may be a down-conversion mixer. The quadrature mixer 234 may be a down-conversion mixer.

The receiver path 221 may further include an in-phase filter 236 to filter the in-phase amplified signal 233 provided by the in-phase mixer 232 and a quadrature filter 238 to filter the quadrature amplified signal 235 provided by the quadrature mixer 234. The in-phase filter 236 may be a low pass filter. The quadrature filter 238 may be a low pass filter.

The received signal 224 may be processed by the amplifier 230, the in-phase mixer 232, the quadrature mixer 234, the in-phase filter 236 and the quadrature filter 238 to recover a phase of binary phase shift keying (BPSK) signals.

The receiver path 221 may include an in-phase variable gain amplifier 240 to amplify the filtered in-phase signal 241 and a quadrature variable gain amplifier 242 to amplify the filtered quadrature signal 243. The receiver path 221 may include an in-phase integration circuit 244 coupled to an output 245 of the in-phase variable gain amplifier 240 to receive the amplified filtered in-phase signal 246 and to produce an analog integrated in-phase signal 247, and a quadrature integration circuit 248 coupled to an output 249 of the quadrature variable gain amplifier 242 to receive the amplified filtered quadrature signal 250 and to produce an analog integrated quadrature signal 251.

The receiver path 221 may include an in-phase analog-to-digital converter (ADC) 252 to convert the analog integrated in-phase signal 247 provided by the in-phase integration circuit 244 to a digital integrated in-phase signal 253, and a quadrature analog-to-digital converter (ADC) 254 to convert the analog integrated quadrature signal 251 provided by the quadrature integration circuit 248 to a digital integrated quadrature signal 255.

The clock recovery circuit 222 in the receiver path 221 may be coupled to the output 245 of the in-phase variable gain amplifier 240 to receive the amplified filtered in-phase signal 246 and to the output 249 of the quadrature variable gain amplifier 242 to receive the amplified filtered quadrature signal 250. The clock recovery circuit 222 may include a first squaring circuit 256 to produce a first squared output 257 and a second squaring circuit 258 to produce a second squared output 259. The clock recovery circuit 222 may include a summing circuit 260 to combine the first squared output 257 and the second squared output 259 to form a summed output 261. The clock recovery circuit 222 may also include a first low pass filter 262 to filter the summed output 261 provided by the summing circuit 260 to recover the receiver clock signal 223.

The receiver clock signal 223 may be sent to a receiver clock circuit 263 coupled to the first low pass filter 262. A receiver signal circuit 264 may be coupled to the receiver clock circuit 263. The receiver signal circuit 264 may be coupled to the in-phase analog-to-digital converter (ADC) 252 to receive the digital integrated in-phase signal 253 and may be coupled to the quadrature analog-to-digital converter (ADC) 254 to receive the digital integrated quadrature signal 255. The digital integrated in-phase signal 253 and the digital integrated quadrature signal 255 may be used to recover the digital data received by the receiver 204 of the communication device 200.

The comparator circuit 226 may include an edge detector 266 to compare the receiver clock signal 223 and the transmitter clock signal 209 to generate an output pulse signal 267. The edge detector 266 may determine a delay time between a rising edge of the transmitter clock signal 209 and a rising edge of the receiver clock signal 223. The output pulse signal 267 may represent the delay time between the rising edge of the transmitter clock signal 209 and the rising edge of the receiver clock signal 223.

The comparator circuit 226 may include a second low pass filter 268 to filter the output pulse signal 267 provided by the edge detector 266 to produce an analog output signal 269. The analog output signal 269 may be proportional to the delay time between the rising edge of the transmitter clock signal 209 and the rising edge of the receiver clock signal 223.

The receiver path 221 may include a first analog-to-digital converter (ADC) 270 to convert the analog output signal 269 provided by the second low pass filter 268 to a digital output signal 271. The first analog-to-digital converter (ADC) 270 may be coupled between the second low pass filter 268 and the ranging determination circuit 228. The digital output signal 271 may be used to determine the ranging value.

The frequency generator 206 of the communication device 200 may provide oscillator signals. The frequency generator 206 may be coupled to the mixer 216 of the transmitter 202 to provide a transmitter oscillator signal 272 to the mixer 216. The frequency generator 206 may be coupled to the in-phase mixer 232 of the receiver 204 to provide an in-phase receiver oscillator signal 273 to the in-phase mixer 232. The frequency generator 206 may be coupled to the quadrature mixer 234 of the receiver 204 to provide a quadrature receiver oscillator signal 274 to the quadrature mixer 234.

The frequency generator 206 may include a voltage-controlled oscillator (VCO) 276 configured to generate at least one oscillator output signal. The VCO 276 may be a multi-tone VCO. The frequency generator 206 may include a first buffer circuit 277 and a second buffer circuit 278 coupled to the voltage control oscillator 276 to buffer the at least one oscillator output signal.

The frequency generator 206 may include a coarse tuning circuit 279 coupled to the first buffer circuit 277 to provide coarse tuning of the frequency to the voltage control oscillator 276. The frequency generator 206 may also include a fine tuning circuit 280 coupled to the coarse tuning circuit 279 to provide fine tuning of the frequency to the voltage control oscillator 276.

The first buffer circuit 277 may be coupled to the mixer 216 to provide the transmitter oscillator signal 272 to the mixer 216. The second buffer circuit 278 may be coupled to the in-phase mixer 232 to provide the in-phase receiver oscillator signal 273 to the in-phase mixer 232. The second buffer circuit 278 may be coupled to the quadrature mixer 234 to provide the quadrature receiver oscillator signal 274 to the quadrature mixer 234.

The communication device 200 may include a switch 281 coupled between the amplifier 230 of the transmitter 202 and the amplifier 220 of the receiver 204. The switch 281 may be coupled to an antenna 282 of the communication device 200.

The communication device 200 may further include a baseband processor 284. The baseband processor 284 may include a burst power control module 286. The baseband processor 284 may also include the transmitter clock generating circuit 208, the transmitter signal generating circuit 215, the ranging determination circuit 228, the receiver clock circuit 263 and the receiver signal circuit 264.

The duration of UWB pulses may occupy a small duty of data rate (<5%), allowing the transmitter 202 or the receiver 204 to power down when there is no pulse transmission.

The communication device 200 may work in a half duplex mode when the communication device 200 is used for communication. For example, either transmitter A (or transmitter B) communicates with receiver A (or receiver B) at one time.

For ranging and localization, the communication device 200 may operate in a scheme called two-way ranging. A dedicated preamble may be defined to be used for ranging purpose. For example, transmitter A sends a preamble pulse sequence (e.g. synchronized by a transmitter clock TX_clk) to receiver B. Receiver B receives the pulses and then triggers transmitter B to send a pulse train to receiver A. After receiver A receives the pulse train from transmitter B, receiver A recovers a receiver clock RC_clk. From TX_clk and RC_clk, a ranging information can be extracted. Assuming that the time delay between the two clock edges is Δt_{d} and the total processing time (including detection time of receivers B and A, relay time from receiver B to transmitter B etc.) is Δtᵣ, the distance between communication device A and communication device B can be calculated as d=(Δt_{d}−Δtᵣ)c/2 where c represents the velocity of light.

If the clock of transmitter A and the clock of transmitter B can be synchronized, one-way ranging may be used to calculate the delay between the transmitter clock of the transmitter and the recovered receiver clock of the receiver within the same communication device 200. Once the ranging information is obtained, localization can be attained by coordinating and merging more than two different ranging data for an object. The proper operation/switching of communication and ranging mode of the communication device 200 may be controlled by 802.15.4a MAC.

Limited by the jitter performance of the recovered clock, the ranging circuits can achieve 0.2 ns edge detection accuracy. This can equal to 3 cm ranging accuracy. A coverage of >60 m range can be expected by using an 11 bit ADC.

Based on the above discussion, another example of the communication device 200 may include a clock recovery circuit 222 configured to recover a receiver clock signal 223 from a received radio preamble signal 224 comprising a preamble code, and a ranging determination circuit 228 configured to determine a ranging value based on the preamble signal 224.

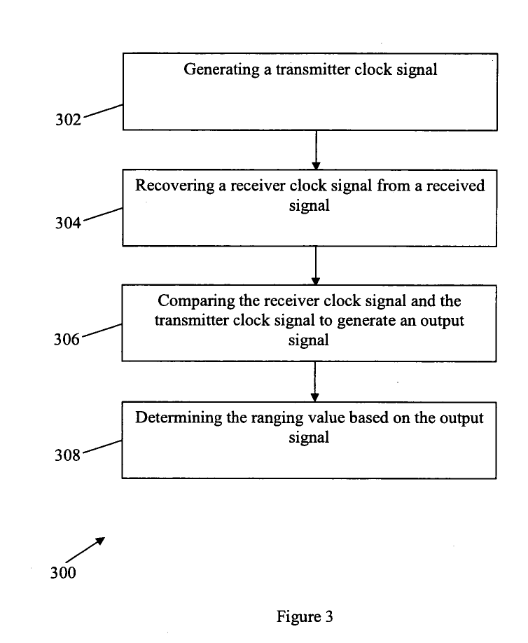

FIG. 3 shows a flowchart 300 of a process for determining a ranging value in the communication device 200 according to an embodiment. At 302, a transmitter clock signal may be generated. At 304, a receiver clock signal from a received signal may be recovered. At 306, the receiver clock signal and the transmitter clock signal may be compared to generate an output signal. At 308, a ranging value may be determined based on the output signal.

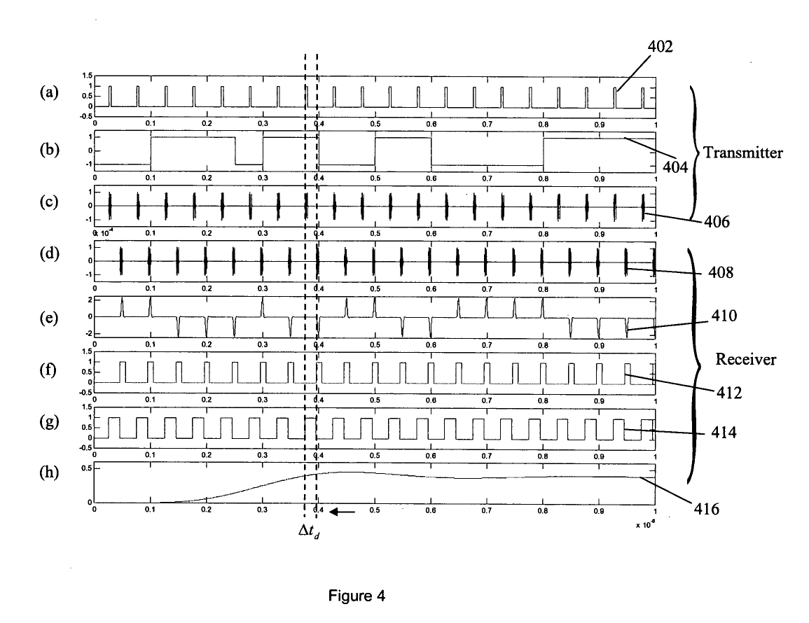

For better illustration, FIG. 4 shows data flow of the communication device 200 at a system level according to an embodiment. FIG. 4(a) shows UWB pulse train 402 triggered by the transmitter clock generating circuit 208. FIG. 4(b) shows a modulation signal 404. FIG. 4(c) shows the transmitted pulses 406. If two-way ranging as discussed above is used, the received pulse 408 by the receiver 204 as shown in FIG. 4(d) may have delay from the transmitted pulses 406 of FIG. 4(c) due to the transmission and/or turn around time. FIG. 4(e) shows a demodulation signal 410. FIG. 4(f) shows the recovered receiver clock 412. The recovered receiver clock 412 may be recovered from the demodulation signal 410. FIG. 4(g) shows a digital pulse train 414 formed by combining the rising edge of the transmitter clock signal 402 of FIG. 4(a) and the rising edge of the recovered receiver clock 412 of FIG. 4(f). After low-pass filtering of the digital pulse train 414 of FIG. 4(g), an averaged output 416 shown in FIG. 4(h) may be generated. The averaged output 416 may be proportional to the delay time and can be used for ranging.

Details of the components of an embodiment of the transmitter 202 of the communication device 200 are described below.

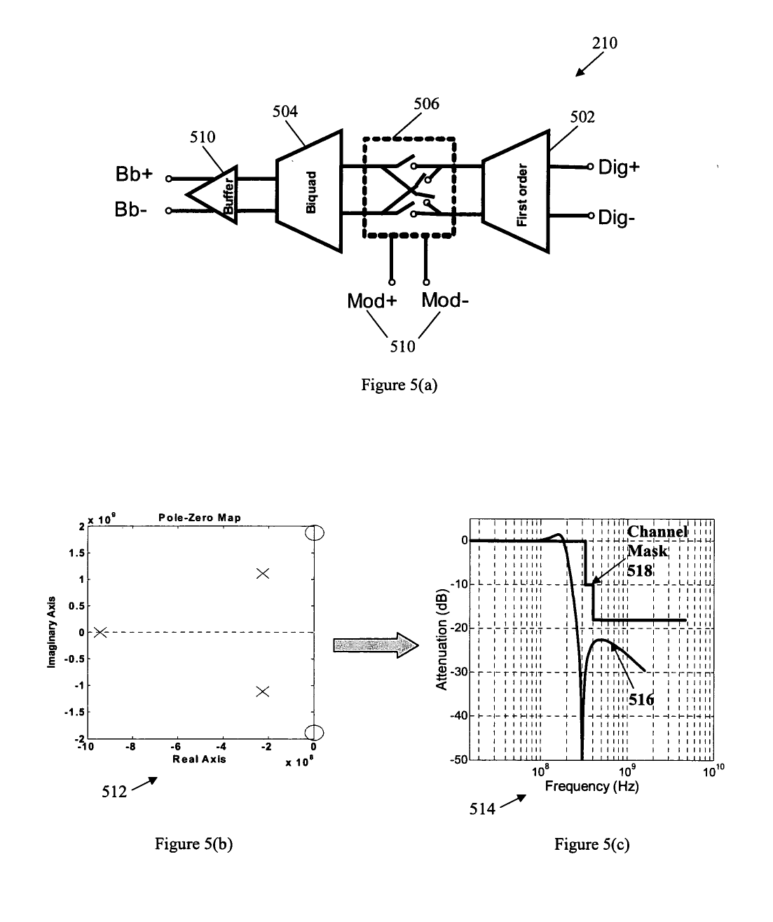

FIG. 5(a) shows a schematic diagram of the pulse shaper 210 and the modulator 212 of the transmitter 202 according to an embodiment. The pulse shaper 210 may be a third order Elliptic lowpass filter. The pulse shaper 210 and the modulator 212 may include a first order filter 502 and a biquad Gm-C filter 504. The first order filter 502 and the biquad Gm-C filter 504 may include dedicated pole-zero placements to generate channel mask compliant pulses. Four switches 506 may be coupled between the first order filter 502 and the biquad Gm-C filter 504. The four switches 506 may be controlled by modulation data 508 to change the polarity of the pulses. A buffer circuit 510 may be coupled to the biquad Gm-C filter 504. Using passive switches 506 for the modulator 212 and liberalized transconductance for the pulse shaper 210 may achieve very good linearity which attain a maximum input swing of 1V peak to peak and an output swing of 800 mV peak to peak.

FIG. 5(b) shows a pole-zero map 512 with an imaginary axis plotted against a real axis of the pulse shaper and the modulator according to an embodiment. FIG. 5(c) shows a graph 514 of attenuation plotted against frequency of the pulse shaper and the modulator according to an embodiment. The graph 514 shows that a frequency response 516 is constrained within a channel mask 518 with a margin. This takes into account the possible spectral spreading of the transmitted signal 209 due to nonlinearity which may be caused by the mixer 216 and the amplifier 220.

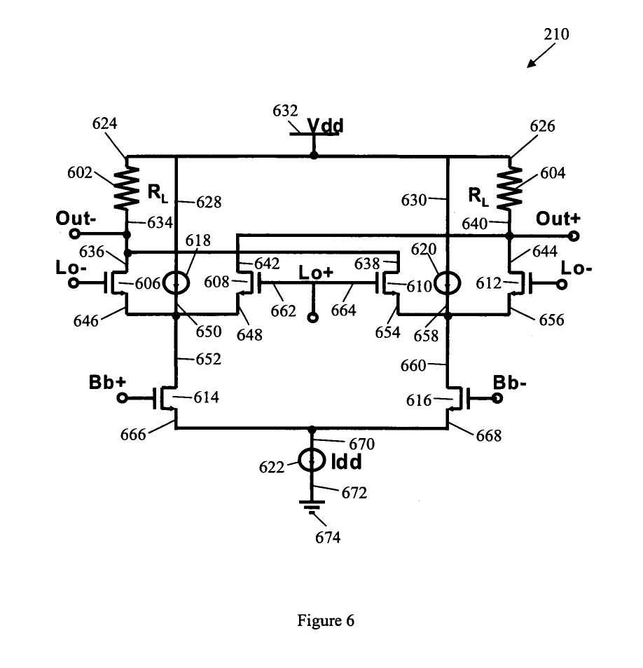

FIG. 6 shows a schematic diagram of the mixer 216 of the transmitter 202 according to an embodiment. The mixer 216 may be an upconvertor, which can be a Gilbert-cell active mixer optimized for high linearity and resistively loaded to cover the full UWB band. The mixer 216 may achieve a conversion gain of −9.6 dB, IIP3 (third order input intercept point) of 15.2 dBm, NF (noise figure) of 15.4 dB.

The mixer 216 may be resistively loaded by two resistors R_{L} 602, 604 for a wide band performance over the entire bandwidth. The mixer 216 may include six transistors 606, 608, 610, 612, 614, 616, and three current sources 618, 620, 622. A first terminal 624 of the resistor 602, a first terminal 626 of the resistor 604, an input terminal 628 of the current source 618, and an input terminal 630 of the current source 620 may be coupled to a supply voltage 632. A second terminal 634 of the resistor 602 may be coupled to a drain terminal 636 of the transistor 606 and a drain terminal 638 of the transistor 610. A second terminal 640 of the resistor 604 may be coupled to a drain terminal 642 of the transistor 608 and a drain terminal 644 of the transistor 612. A source terminal 646 of the transistor 606 may be coupled to a source terminal 648 of the transistor 608, an output terminal 650 of the current source 618 and a drain terminal 652 of the transistor 614. A source terminal 654 of the transistor 610 may be coupled to a source terminal 656 of the transistor 612, an output terminal 658 of the current source 620 and a drain terminal 660 of the transistor 616. A gate terminal 662 of the transistor 608 may be coupled to a gate terminal 664 of the transistor 610. A source terminal 666 of the transistor 614 may be coupled to a source terminal 668 of the transistor 616 and an input terminal 670 of the current source 622. An output terminal 672 of the current source 622 may be coupled to ground 674.

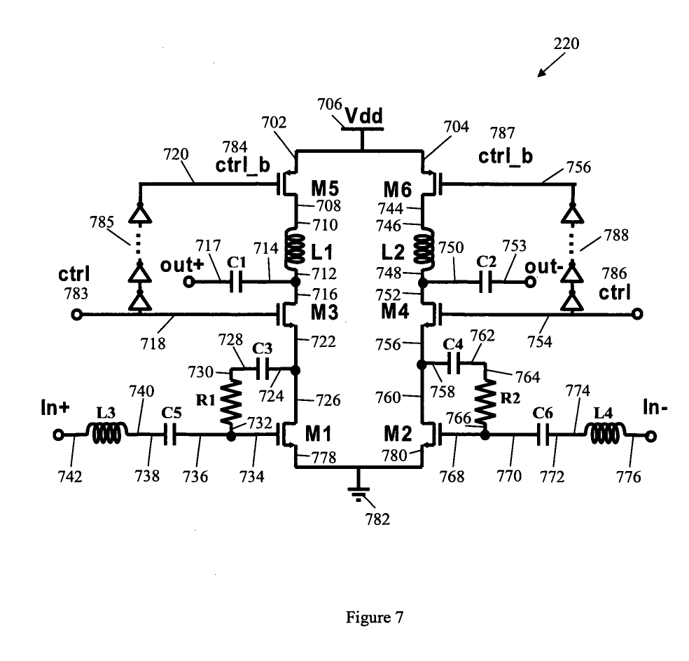

FIG. 7 shows a schematic diagram of the amplifier 220 of the transmitter 202 according to an embodiment. The amplifier 220 may be a differential driver amplifier. A switched Class-A amplifier may be used as the differential driver amplifier in order to preserve the constrained spectral and to improve the efficiency. The amplifier 220 may include six transistors M1 to M6, four inductors L1 to L4, six capacitors C1 to C6, and two resistors R1 and R2.

A drain terminal 702 of transistor M5 and a drain terminal 704 of transistor M6 may be coupled to a supply voltage 706. A source terminal 708 of transistor M5 may be coupled to a first terminal 710 of inductor L1. A second terminal 712 of inductor L1 may be coupled to a first terminal 714 of capacitor C1 and a drain terminal 716 of transistor M3. A second terminal 717 of capacitor C1 may be coupled to an output terminal out+. A gate terminal 718 of transistor M3 and a gate terminal 720 of transistor M5 may be coupled to complementary control inputs Ctrl 783 and Ctrl_b 784 respectively. A series of NOT gates 785 may be coupled between the gate terminal 718 of transistor M3 and the gate terminal 720 of transistor M5. A source terminal 722 of transistor M3 may be coupled to a first terminal 724 of capacitor C3 and a drain terminal 726 of transistor M1. A second terminal 728 of capacitor C3 may be coupled to a first terminal 730 of resistor R1. A second terminal 732 of resistor R1 may be coupled to a gate terminal 734 of transistor M1 and a first terminal 736 of capacitor C5. A second terminal 738 of capacitor C5 may be coupled to a first terminal 740 of inductor L3. A second terminal 742 of inductor L3 may be coupled to an input terminal In+.

A source terminal 744 of transistor M6 may be coupled to a first terminal 746 of inductor L2. A second terminal 748 of inductor L2 may be coupled to a first terminal 750 of capacitor C2 and a drain terminal 752 of transistor M4. A second terminal 753 of capacitor C2 may be coupled to an output terminal out−. A gate terminal 754 of transistor M4 and a gate terminal 756 of transistor M5 may be coupled to complementary control inputs Ctrl 786 and Ctrl_b 787 respectively. A series of NOT gates 788 may be coupled between the gate terminal 754 of transistor M4 and the gate terminal 756 of transistor M5. A source terminal 756 of transistor M4 may be coupled to a first terminal 758 of capacitor C4 and a drain terminal 760 of transistor M2. A second terminal 762 of capacitor C4 may be coupled to a first terminal 764 of resistor R2. A second terminal 766 of resistor R2 may be coupled to a gate terminal 768 of transistor M2 and a first terminal 770 of capacitor C6. A second terminal 772 of capacitor C6 may be coupled to a first terminal 774 of inductor L4. A second terminal 776 of inductor L4 may be coupled to an input terminal In−. A source terminal 778 of transistor M1 and a source terminal 780 of transistor M2 may be coupled to ground 782.

The transistors M3/M4 and M5/M6 can allow the amplifier 220 to be turned off when there is no pulse transmission. The complementary control inputs Ctrl and Ctrl_b may be slightly delayed from each other using the series of NOT gates 785, 788 to prevent undesired pulse generation by inductors L1/L2 during fast transitions of the control signals. The transistors M1/M2 may have resistive feedback to improve the bandwidth. The amplifier 220 may adopt a resistive feedback topology in order to provide a gain over the entire bandwidth. The amplifier 220 may achieve a gain of 6-8 dB, BW (bandwidth) of 6 GHz (3-9 GHz), and maximum output power of 8 dBm. The transmitter 202 may be consuming a peak current of 8 mA to generate 500 MHz PRF pulses.

Details of the components of an embodiment of the receiver 204 of the communication device 200 are described below.

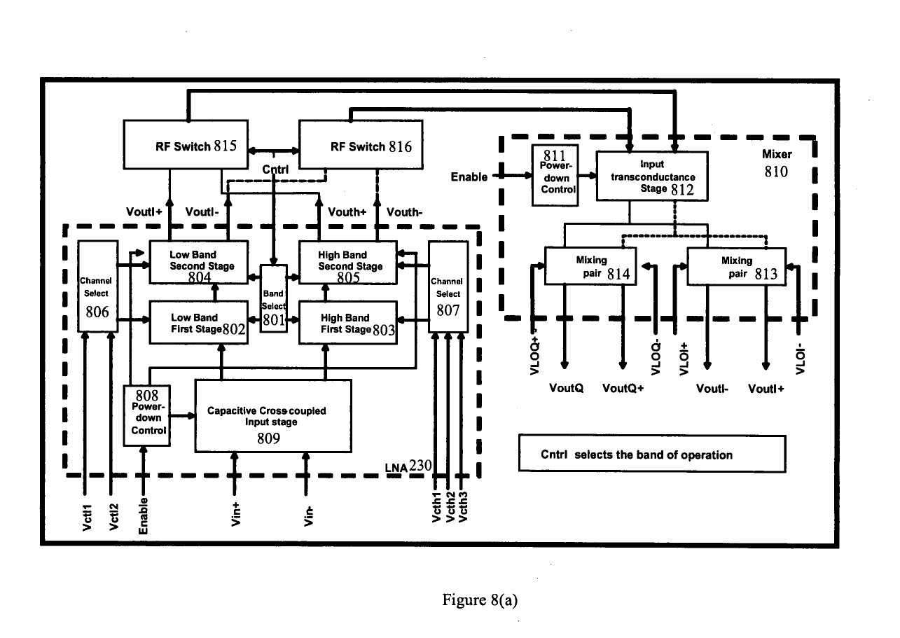

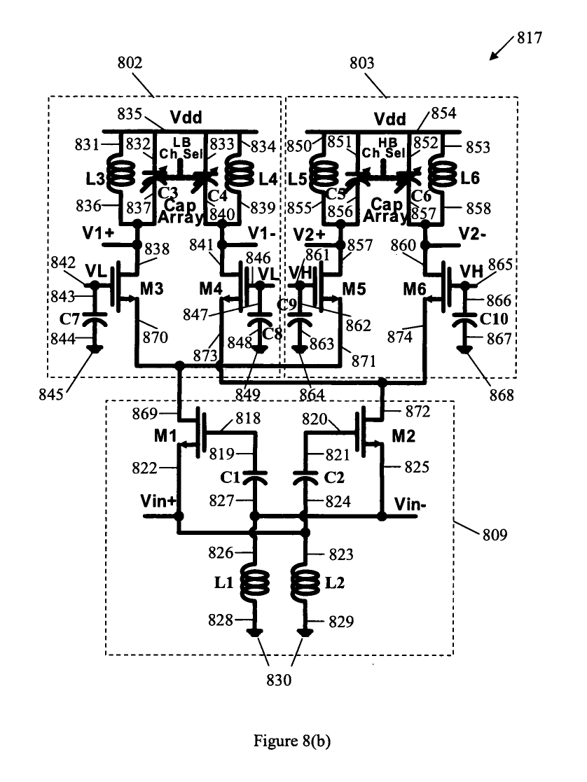

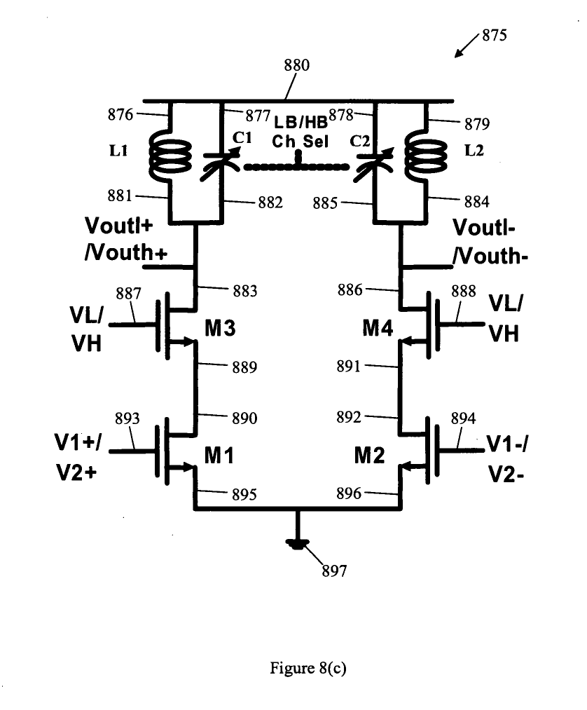

FIG. 8(a) shows a schematic diagram of the amplifier 230 of the receiver 204 according to an embodiment. The amplifier 230 may be a low noise amplifier (LNA). The LNA 230 may include a band select circuit 801 controlled by a signal Cntrl. The band select circuit 801 may be coupled to a low band first stage circuit 802, a high band first stage circuit 803, a low band second stage circuit 804 and a high band second stage circuit 805. The low band first stage circuit 802 may be coupled to the low band second stage circuit 804. The high band first stage circuit 803 may be coupled to the high band second stage circuit 805.

A first channel select circuit 806 may be coupled to the low band first stage circuit 802 and the low band second stage circuit 804. A second first channel select circuit 807 may be coupled to the high band first stage circuit 803 and the high band second stage circuit 805. A power-down control circuit 808 may be coupled to a capacitive cross coupled input stage circuit 809. The power-down control circuit 808 may be coupled to the low band second stage circuit 804 and the high band second stage circuit 805. The capacitive cross coupled input stage circuit 809 may be coupled to low band first stage circuit 802 and the high band first stage circuit 803.

The LNA 230 may be designed to operate at one channel at any time through band switching and channel selection to minimize power consumption. The capacitive cross coupled input stage circuit 809 may be used to boost the Gm and to reduce input referred noise while achieving good input matching. The band switching between low and high band can be done by transistors M3/M4 and M5/M6 where there are two LC tanks to cover either low band or high band. Within each band, there may be two stage cascaded amplifiers. The first stage can be a LC tuned loading stage where the capacitor bank may be employed to tune to the desired channel. The second stage can be a common source amplifier with LC tunable loading network.

FIG. 8(a) also shows a schematic diagram of the mixer 810 of the receiver 204 according to an embodiment. The mixer 810 may include a power-down control circuit 811 coupled to an input transconductance stage circuit 812. The transconductance stage circuit 812 may be coupled to a first mixing pair 813 (e.g. in-phase mixer 232) and a second mixing pair 814 (e.g. quadrature mixer 234).

A first RF switch 815 and a second RF switch 816 may be coupled between the LNA 230 and the mixer 810. Both the first RF switch 815 and the second RF switch 816 may be coupled to the low band second stage circuit 804, the high band second stage circuit 805 and the transconductance stage circuit 812.

FIG. 8(b) shows a schematic diagram of the first stage circuit 817 of the LNA 230 according to an embodiment. The first stage circuit 817 may include a differential common gate capacitor coupled input stage 809 followed by a first inductive resonant differential stage 802, 803 for each individual bands. Band selection can be controlled by the cascode transistors M3 and M4 or by the cascode transistors M5 and M6 that succeed the input stage transistors M1 and M2. Either the gate voltage (VL) of both M3 and M4 low band differential pair or the gate voltage (VH) of both M5 and M6 high band differential pair can be set to 1.8V (ON) at any one time depending on whichever band is selected. Channel selection (Ch Sel) can be achieved by utilization of a transistor switched capacitor array (Cap Array), e.g. variable capacitors C3 and C4 for low band and variable capacitors C5 and C6 for high band.

The capacitive cross coupled input stage circuit 809 may include two transistors M1 and M2, two polarized capacitors C1 and C2 and two inductors L1 and L2. A gate terminal 818 of transistor M1 may be coupled to a positive terminal 819 of capacitor C1. A gate terminal 820 of transistor M2 may be coupled to a positive terminal 821 of capacitor C2. A source terminal 822 of transistor M1 may be coupled to an input voltage terminal Vin+, a first terminal 823 of inductor L2 and a negative terminal 824 of capacitor C2. A source terminal 825 of transistor M5 may be coupled to an input voltage terminal Vin−, a first terminal 826 of inductor L1 and a negative terminal 827 of capacitor C1. A second terminal 828 of inductor L1 and a second terminal 829 of inductor L2 may be coupled to ground 830.

The low band first stage circuit 802 may include two inductors L3 and L4, two variable capacitors C3 and C4, two transistors M3 and M4, and two polarized capacitors C7 and C8. A first terminal 831 of inductor L3, a positive terminal 832 of capacitor C3, a positive terminal 833 of capacitor C4 and a first terminal 834 of inductor L4 may be coupled to a supply voltage 835. A second terminal 836 of inductor L3 may be coupled to a negative terminal 837 of capacitor C3, a voltage V1+ and a drain terminal 838 of transistor M3. A second terminal 839 of inductor L4 may be coupled to a negative terminal 840 of capacitor C4, a voltage V1− and a drain terminal 841 of transistor M4. A gate terminal 842 of transistor M3 may be coupled to a voltage VL and a positive terminal 843 of capacitor C7. A negative terminal 844 of capacitor C7 may be coupled to ground 845. A gate terminal 846 of transistor M4 may be coupled to a voltage VL and a positive terminal 847 of capacitor C8. A negative terminal 848 of capacitor C8 may be coupled to ground 849.

The high band first stage circuit 803 may include two inductors L5 and L6, two variable capacitors C5 and C6, two transistors M5 and M6, and two polarized capacitors C9 and C10. A first terminal 850 of inductor L5, a positive terminal 851 of capacitor C5, a positive terminal 852 of capacitor C6 and a first terminal 853 of inductor L6 may be coupled to a supply voltage 854. A second terminal 855 of inductor L5 may be coupled to a negative terminal 856 of capacitor C5, a voltage V2+ and a drain terminal 857 of transistor M5. A second terminal 858 of inductor L6 may be coupled to a negative terminal 859 of capacitor C6, a voltage V2− and a drain terminal 860 of transistor M6. A gate terminal 861 of transistor M5 may be coupled to a voltage VH and a positive terminal 862 of capacitor C9. A negative terminal 863 of capacitor C9 may be coupled to ground 864. A gate terminal 865 of transistor M6 may be coupled to a voltage VH and a positive terminal 866 of capacitor C10. A negative terminal 867 of capacitor C10 may be coupled to ground 868.

A drain terminal 869 of transistor M1 of the capacitive cross coupled input stage circuit 809 may be coupled to a source terminal 870 of transistor M3 of the low band first stage circuit 802 and to a source terminal 871 of transistor M5 of the high band first stage circuit 803. A drain terminal 872 of transistor M2 of the capacitive cross coupled input stage circuit 809 may be coupled to a source terminal 873 of transistor M4 of the low band first stage circuit 802 and to a source terminal 874 of transistor M6 of the high band first stage circuit 803.

FIG. 8(c) shows a schematic diagram of the second stage circuit 875 of the LNA 230 according to an embodiment. The second stage circuit 875 may be based upon a simple common-source cascode amplifier configuration. A common-mode current source is not adopted as it may impede upon a voltage head room. As such, an input stage transistor of the second stage circuit 875 is gate biased in this embodiment. Similar to the first stage circuit 817, a capacitance array can allow the second stage circuit 875 to switch the gain between each channel. In this embodiment, 2 bits can be implemented for the low band and 3 bits for the high band.

The second stage circuit 875 may have two inductors L1 and L2, two variable capacitors C1 and C2 and four transistors M1 to M4. A first terminal 876 of inductor L1, a positive terminal 877 of capacitor C1, a positive terminal 878 of capacitor C2 and a first terminal 879 of inductor L2 may be coupled to a supply voltage 880. A second terminal 881 of inductor L1 may be coupled to a negative terminal 882 of capacitor C1, an output voltage Vout1+Nouth+ and a drain terminal 883 of transistor M3. A second terminal 884 of inductor L2 may be coupled to a negative terminal 885 of capacitor C2, an output voltage Vout1−/Vout− and a drain terminal 886 of transistor M4. A gate terminal 887 of transistor M3 and a gate terminal 888 of transistor M4 may be coupled to a voltage VL/VH. A source terminal 889 of transistor M3 may be coupled to a drain terminal 890 of transistor M1 and a source terminal 891 of transistor M4 may be coupled to a drain terminal 892 of transistor M2. A gate terminal 893 of transistor M1 may be coupled to a voltage V1+/V2+ and a gate terminal 894 of transistor M2 may be coupled to a voltage V1−/V2−. A source terminal 895 of transistor M1 may be coupled to a source terminal 896 of transistor M2 and ground 897.

A double balanced differential Gilbert cell may be used as the mixer 810 of the receiver 204 and resistive loads can be adopted to cover the entire UWB band. One single transconductance stage can be used at the input of the mixer 810 to reduce the loading effect of the resistive loads on the LNA 230. The combined RF front-end may achieve a voltage gain of 30.4/21.3 dB, NF of 5.5/7 dB, and IIP3 of −16.7/−10.7 dB for low band and high band respectively.

The filters 236, 238 of the receiver 204 may be implemented by a third-order Elliptical Gm-C filter with a cut-off frequency of 250 MHz. The amplifiers 240, 242 of the receiver 204 may include an automatic offset cancellation circuit and an amplifier circuit.

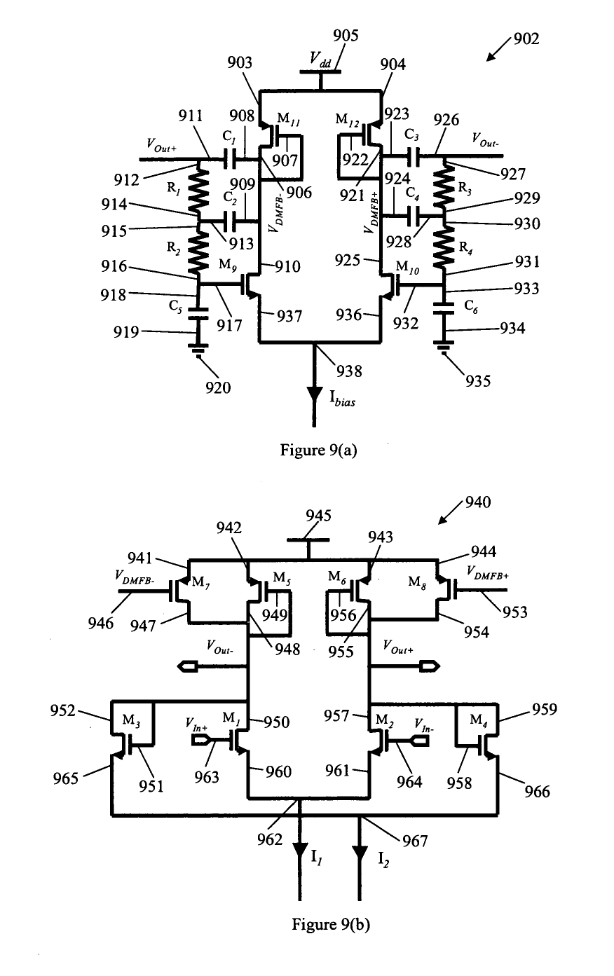

FIG. 9(a) shows a schematic diagram of the automatic offset cancellation circuit 902 according to an embodiment. The offset cancellation circuit 902 may include four transistors M9 to M12, six capacitors C1 to C6 and four resistors R1 to R4. A source terminal 903 of transistor M11 and a source terminal 904 of transistor M12 may be coupled to a supply voltage 905. A drain terminal 906 of transistor M11 may be coupled to a gate terminal 907 of transistor M11, a first terminal 908 of capacitor C1, a first terminal 909 of capacitor C2 and a drain terminal 910 of transistor M9. A second terminal 911 of capacitor C1 may be coupled to a voltage Vₒᵤₜ₊ and a first terminal 912 of resistor R1. A second terminal 913 of capacitor C2 may be coupled to a second terminal 914 of resistor R1 and a first terminal 915 of resistor R2. A second terminal 916 of resistor R2 may be coupled to a gate terminal 917 of transistor M9 and a first terminal 918 of capacitor C5. A second terminal 919 of capacitor C5 may be coupled to ground 920.

A drain terminal 921 of transistor M12 may be coupled to a gate terminal 922 of transistor M12, a first terminal 923 of capacitor C3, a first terminal 924 of capacitor C4 and a drain terminal 925 of transistor M10. A second terminal 926 of capacitor C3 may be coupled to a voltage Vₒᵤₜ₋ and a first terminal 927 of resistor R3. A second terminal 928 of capacitor C4 may be coupled to a second terminal 929 of resistor R3 and a first terminal 930 of resistor R4. A second terminal 931 of resistor R4 may be coupled to a gate terminal 932 of transistor M10 and a first terminal 933 of capacitor C6. A second terminal 934 of capacitor C6 may be coupled to ground 935. A source terminal 936 of transistor M10 may be coupled to a source terminal 937 of transistor M9. A current I_{bias} may flow from a connection point 938 of the source terminal 936 of transistor M10 and the source terminal 937 of transistor M9.

FIG. 9(b) shows a schematic diagram of the amplifier circuit 940 according to an embodiment. The amplifier circuit 940 may include eight transistors M1 to M8. A source terminal 941 of transistor M7, a source terminal 942 of transistor M5, a source terminal 943 of transistor M6, and a source terminal 944 of transistor M8 may be coupled to a supply voltage 945. A gate terminal 946 of transistor M7 may be coupled to voltage V_{DMFB-}. A drain terminal 947 of transistor M7 may be coupled to a drain terminal 948 of transistor M5, a gate terminal 949 of transistor M5, voltage Vₒᵤₜ₋, a drain terminal 950 of transistor M1, a gate terminal 951 of transistor M3, and a drain terminal 952 of transistor M3. A gate terminal 953 of transistor M8 may be coupled to voltage V_{DMFB+}. A drain terminal 954 of transistor M8 may be coupled to a drain terminal 955 of transistor M6, a gate terminal 956 of transistor M6, voltage Vₒᵤₜ₊, a drain terminal 957 of transistor M2, a gate terminal 958 of transistor M4, and a drain terminal 959 of transistor M4. A source terminal 960 of transistor M1 may be coupled to a source terminal 961 of transistor M2. A current I₁ may flow through a connection point 962 of the source terminal 960 of transistor M1 and the source terminal 961 of transistor M2. A gate terminal 963 of transistor M1 may be coupled to a voltage Vᵢₙ₊ and a gate terminal 964 of transistor M2 may be coupled to a voltage Vᵢₙ₋. A source terminal 965 of transistor M3 may be coupled to a source terminal 966 of transistor M4. A current I₂ may flow through a connection point 967 of the source terminal 965 of transistor M3 and the source terminal 966 of transistor M4.

The gain of the amplifiers 240, 242 may be expressed by: Aᵥ=gₘ₁/gₘ₅. Any output DC offset may be detected at the gate terminal 917 of transistor M9 and at the gate terminal 932 of transistor M10 after a respective low-pass RC ladder. The difference in DC levels of Vout+ and Vout− may introduce corresponding opposite DC currents in transistors M7 and M8, which may cancel the effect of DC offset and keep the positive and negative output nodes balanced. The amplifiers 240, 242 may be controlled by a dB-linear V-I converter which regulates I1 and I2. In this embodiment of the amplifiers 240, 242, five consecutive stages are cascaded to obtain the desired gain range. Capacitances C1 to C4 may partially allow high frequency components to pass through and be fed back to transistors M7 and M8, reducing the load currents of transistors M5 and M6, which may eventually enhance the gain of the amplifying stage at high frequencies. The five-stage cascaded dB-linear variable gain amplifier may achieve a dynamic gain from −20 to 50 dB with 400 MHz BW.

The integration circuits 244, 248 of the receiver 204 may be variable bandwidth (BW) integrators. The variable BW integrator may capture the reflected pulses from multipath and extend the duration of the demodulated pulses. For localization purpose, two squaring circuits 256, 258 and a low-pass filter 262 (e.g. nonlinear low-pass filter (NLPF)) may be used to regenerate RC_clk. The squaring circuits 256, 258 may be used to detect the signal energy and the filter 262 may be used to boost signal level to rail-to-rail. Using the edge detector 266, a digital pulse train can be turned on and off at the rising edge of TX_clk and RC_clk respectively. A low pass filter 268 (e.g. a passive fifth-order RC LPF) with a cutoff frequency of 500 kHz may be applied to average the jitter and noise and hence significantly improves the ranging accuracy. Operating at 500 MHz PRF, the peak current of the receiver 204 can be 31 mA.

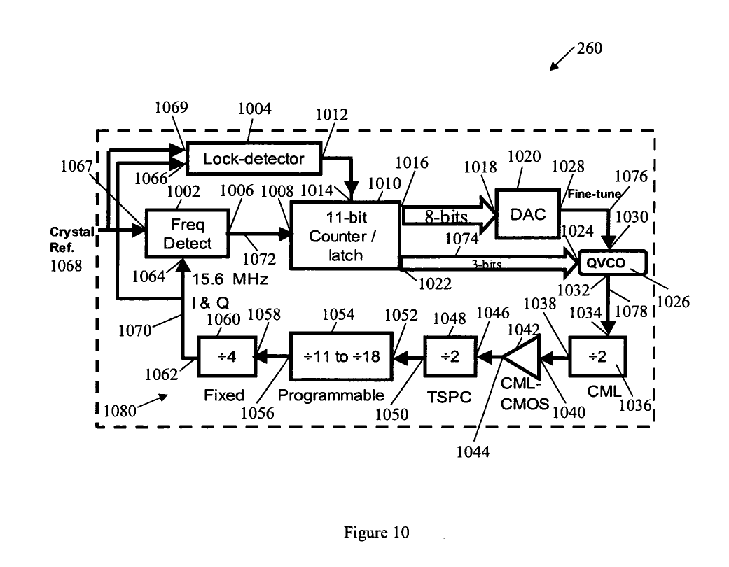

FIG. 10 shows a schematic diagram of the frequency generator 206 according to an embodiment. The frequency generator 206 may be a nine-tone frequency generator. The frequency generator 206 may include a frequency detector 1002 and a lock detector 1004. An output terminal 1006 of the frequency detector 1002 may be coupled to a first input terminal 1008 of an 11 bit counter/latch 1010. An output terminal 1012 of the lock detector 1004 may be coupled to a second input terminal 1014 of the 11 bit counter/latch 1010. A first output terminal 1016 of the 11 bit counter/latch 1010 may be coupled to an input terminal 1018 of a digital to analog converter (DAC) 1020 and a second output terminal 1022 of the 11 bit counter/latch 1010 may be coupled to a first input terminal 1024 of a quadrature voltage-controlled oscillator (QVCO) 1026. An output terminal 1028 of the DAC 1020 may be coupled to a second input terminal 1030 of the QVCO 1026. An output terminal 1032 of the QVCO 1026 may be coupled to an input terminal 1034 of a current mode logic (CML) divider 1036. An output terminal 1038 of the CML divider 1036 may be coupled to an input terminal 1040 of a CML-CMOS converter 1042. An output terminal 1044 of the CML-CMOS converter 1042 may be coupled to an input terminal 1046 of a true single phase clock (TPSC) 1048. An output terminal 1050 of the TSPC 1048 may be coupled to an input terminal 1052 of a programmable divider 1054. An output terminal 1056 of the programmable divider 1054 may be coupled to an input terminal 1058 of a fixed divider 1060. An input terminal 1062 of the fixed divider 1060 may be coupled to a first input terminal 1064 of the frequency detector 1002 and a first input terminal 1066 of the lock detector 1004.

A signal 1068 representing a crystal frequency reference may be sent to a second input terminal 1067 of the frequency detector 1002 and a second input terminal 1069 of the lock detector 1004. A signal 1070 representing a frequency may be sent to the frequency detector 1002 from the fixed divider 1060. The frequency detector 1002 may compare the crystal frequency reference 1068 and the frequency 1070. If there is a difference in frequency between the crystal frequency reference 1068 and the frequency 1070, the frequency detector 1002 may send a signal 1072 representing a VCO tuning voltage to the 11 bit counter/latch 1010. The VCO tuning voltage may be stored as a digital word in the 11-bit counter/latch 1010, where three digital bits 1074 are for coarse tuning and 8-bit DAC outputs 1076 are for fine tuning. Basically, the coarse tuning may be carried out through the digital setting of the on-off of capacitor banks. The eight possible combinations of capacitor bank setting can roughly cover the 12 channel frequency range of the frequency generator 206. The fine tuning may be carried out through a digital phase locked loop. The 11-bit counter/latch 1010 may work as a charge pump and a loop filter, and the digital control bits may be converted to analog voltage through the 8 bit DAC 1020.

The three digital bits 1074 and the 8-bit DAC outputs 1076 may be sent to the QVCO 1026. An output signal 1078 of the QVCO 1026 representing a frequency may be processed by the CML divider 1036. The CML divider 1036 may work in the 3-5 GHz frequency range. In 0.18 um CMOS, CML can be a suitable topology for the divider.

The output signal 1078 may be processed by the CML-CMOS converter 1042, the TSPC 1048 and the programmable divider 1054. The programmable divider 1054 can be set so that the center frequency of 12 channels can be covered. The programmable divider 1054 can be based on the TSPC topology.

In this embodiment, a digital frequency tuning loop 1080 can be used to lock the QVCO output frequency to e.g. an external 15.6 MHz crystal reference. Once the QVCO 1026 is tuned to the desired channel, as determined by the lock detector 1004, the tuning loop 1080 can be powered off. The accuracy of frequency tuning may be <10 MHz, which may be limited by DAC resolution.

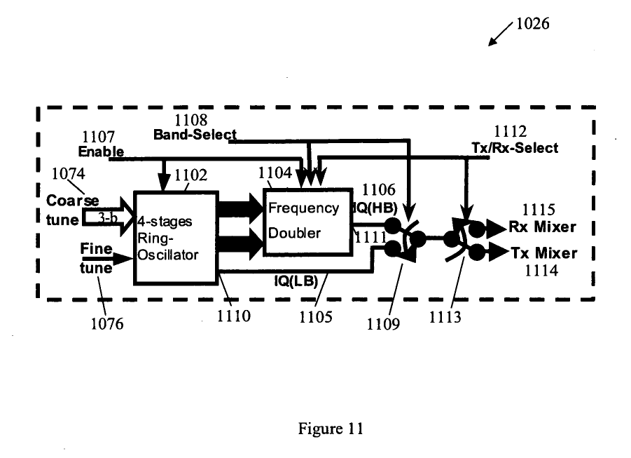

FIG. 11 shows a schematic diagram of the QVCO 1026 according to an embodiment. To significantly reduce the die size, a four-stage ring oscillator 1102 and a frequency doubler 1104 may be used as the QVCO 1026. The ring oscillator 1102 may generate 45°/90° phase difference local oscillations (LOs) covering 2.8-4.75 GHz, and the frequency doubler 1104 may generate quadrature LOs covering 5.6-9 GHz. The measured QVCO starting up time may be 5.39 ns, and the phase noise may be −90 dBc/Hz at 1 MHz offset for 4.5 GHz LO with output power of −2.1 dBm. The peak current may be 40 mA. All buffers used in the QVCO 1026 may use the same structure with different transistor sizes to drive different loadings.

The three digital bits 1074 (coarse tuning) and the 8-bit DAC outputs 1076 (fine tuning) may be sent to the ring oscillator 1102. In this embodiment, V0, V1 and V2 may be used for coarse tuning and Vctrl may be used for fine tuning. The ring oscillator 1102 coupled to the frequency doubler 1104 may send in-phase (I) and quadrature (Q) signals to the frequency doubler 1104. The ring oscillator 1102 may output an IQ(LB(low band)) signal 1105. The frequency doubler 1104 may output an IQ(HB(high band)) signal 1106. An ENABLE signal 1107 may be sent to both the ring oscillator 1102 and the frequency doubler 1104. When the ENABLE signal 1107 is 1, the frequency doubler 1104 may be off. When the ENABLE signal 1107 is 0, the frequency doubler 1104 may be on. A Band-Select signal 1108 may be sent to the frequency doubler 1104 and a switch 1109. The switch 1109 may be coupled to an output terminal 1110 of the ring oscillator 1102 if low band (LB) is selected. The switch 1109 may be coupled to an output terminal 1111 of the frequency doubler 1104 if high band (HB) is selected. A Tx/Rx-Select signal 1112 may be sent to the frequency doubler 1104 and a switch 1113. The switch 1122 may be coupled to the transmitter (TX) mixer 1114 if a Tx-Select signal 1112 is sent. The switch 1122 may be coupled to the receiver (RX) mixer 1115 if an Rx-Select signal 1112 is sent.

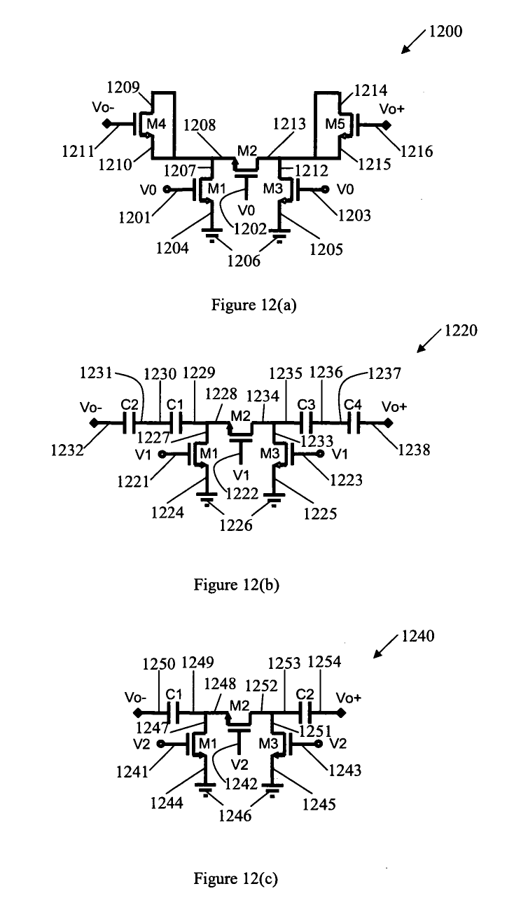

FIG. 12(a) shows a schematic diagram of a coarse tuning control circuit 1200 for a first bit according to an embodiment. The circuit 1200 may have five transistors M1 to M5. A gate terminal 1201 of transistor M1, a gate terminal 1202 of transistor M2 and a gate terminal 1203 of transistor M3 may be coupled to a voltage V0. A source terminal 1204 of transistor M1 and a source terminal 1205 of transistor M3 may be coupled to ground 1206. A drain terminal 1207 of transistor M1 may be coupled to a source terminal 1208 of transistor M2, a drain terminal 1209 of transistor M4 and a source terminal 1210 of transistor M4. A gate terminal 1211 of transistor M4 may be coupled to a voltage Vo−. A drain terminal 1212 of transistor M3 may be coupled to drain terminal 1213 of transistor M2, a drain terminal 1214 of transistor M5 and a source terminal 1215 of transistor M5. A gate terminal 1216 of transistor M5 may be coupled to a voltage Vo+.

FIG. 12(b) shows a schematic diagram of a coarse tuning control circuit 1220 for a second bit according to an embodiment. The circuit 1220 may have three transistors M1 to M3 and four capacitors C1 to C4. A gate terminal 1221 of transistor M1, a gate terminal 1222 of transistor M2 and a gate terminal 1223 of transistor M3 may be coupled to a voltage V1. A source terminal 1224 of transistor M1 and a source terminal 1225 of transistor M3 may be coupled to ground 1226. A drain terminal 1227 of transistor M1 may be coupled to a source terminal 1228 of transistor M2 and a first terminal 1229 of capacitor C1. A second terminal 1230 of capacitor C1 may be coupled to a first terminal 1231 of capacitor C2. A second terminal 1232 of capacitor C2 may be coupled to a voltage Vo−. A drain terminal 1233 of transistor M3 may be coupled to a drain terminal 1234 of transistor M2 and a first terminal 1235 of capacitor C3. A second terminal 1236 of capacitor C3 may be coupled to a first terminal 1237 of capacitor C4. A second terminal 1238 of capacitor C4 may be coupled to a voltage Vo+.

FIG. 12(c) shows a schematic diagram of a coarse tuning control circuit 1240 for a third bit according to an embodiment. The circuit 1220 may have three transistors M1 to M3 and two capacitors C1 and C2. A gate terminal 1241 of transistor M1, a gate terminal 1242 of transistor M2 and a gate terminal 1243 of transistor M3 may be coupled to a voltage V2. A source terminal 1244 of transistor M1 and a source terminal 1245 of transistor M3 may be coupled to ground 1246. A drain terminal 1247 of transistor M1 may be coupled to a source terminal 1248 of transistor M2 and a first terminal 1249 of capacitor C1. A second terminal 1250 of capacitor C1 may be coupled to a voltage Vo−. A drain terminal 1251 of transistor M3 may be coupled to a drain terminal 1252 of transistor M2 and a first terminal 1253 of capacitor C2. A second terminal 1254 of capacitor C2 may be coupled to a voltage Vo+.

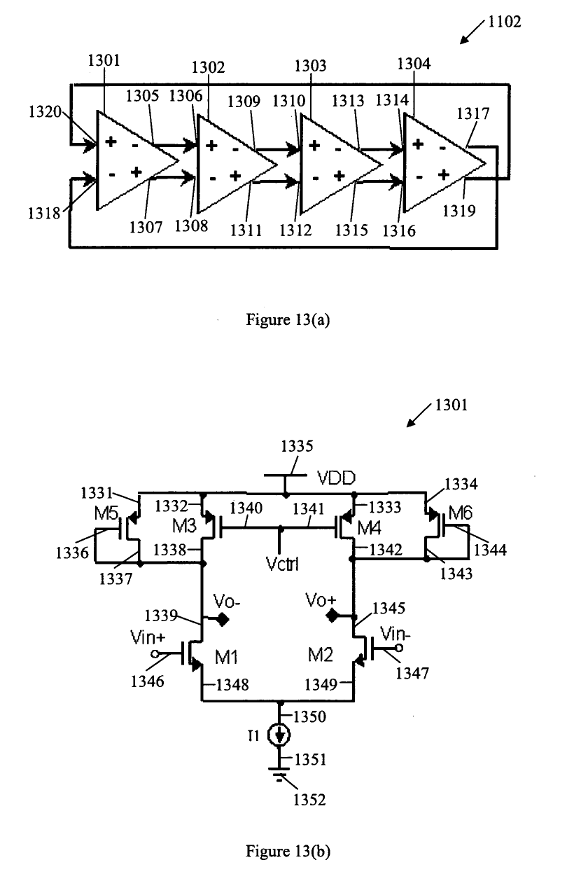

FIG. 13(a) shows a schematic diagram of the ring oscillator 1102 of the QVCO 1026 according to an embodiment. The ring oscillator 1102 may have four delay cells 1301, 1302, 1303, 1304. A negative output terminal 1305 of a first delay cell 1301 may be coupled to a positive input terminal 1305 of a second delay cell 1302. A positive output terminal 1307 of the first delay cell 1301 may be coupled to a negative input terminal 1308 of the second delay cell 1302. A negative output terminal 1309 of the second delay cell 1302 may be coupled to a positive input terminal 1310 of a third delay cell 1303. A positive output terminal 1311 of the second delay cell 1302 may be coupled to a negative input terminal 1312 of the third delay cell 1303. A negative output terminal 1313 of the third delay cell 1303 may be coupled to a positive input terminal 1314 of a fourth delay cell 1304. A positive output terminal 1315 of the third delay cell 1303 may be coupled to a negative input terminal 1316 of the fourth delay cell 1304. A negative output terminal 1317 of the fourth delay cell 1304 may be coupled to a negative input terminal 1318 of the first delay cell 1301. A positive output terminal 1319 of the fourth delay cell 1304 may be coupled to a positive input terminal 1320 of the first delay cell 1301.

FIG. 13(b) shows a schematic diagram of the first delay cell 1301 of the ring oscillator 1102 according to an embodiment. The second delay cell 1302, the third delay cell 1303 and the fourth delay cell 1304 may have the same circuit layout as the first delay cell 1301. The delay cell 1301 may have six transistors M1 to M6 and a current source I1. The delay cell 1301 may have differential N-MOS input pair (transistors M1 and M2), resistive loading represented by using transistors M3 and M4 in linear region and transistors M5 and M6.

A source terminal 1331 of transistor M5, a source terminal 1332 of transistor M3, a source terminal 1333 of transistor M4 and a source terminal 1334 of transistor M6 may be coupled to a source voltage 1335. A gate terminal 1336 of transistor M5 may be coupled to a drain terminal 1337 of transistor M5, a drain terminal 1338 of transistor M3, a voltage Vo− and a drain terminal 1339 of transistor M1. A gate terminal 1340 of transistor M3 may be coupled to a voltage Vctrl and a gate terminal 1341 of transistor M4. A drain terminal 1342 of transistor M4 may be coupled to a drain terminal 1343 of transistor M6, a gate terminal 1344 of transistor M6, a voltage Vo+ and a drain terminal 1345 of transistor M2. A gate terminal 1346 of transistor M1 may be coupled to a voltage Vin+ and a gate terminal 1347 of transistor M2 may be coupled to a voltage Vin−. A drain terminal 1348 of transistor M1 and a drain terminal 1349 of transistor M2 may be coupled to an input terminal 1350 of current source I1. An output terminal 1351 of current source I1 may be coupled to ground 1352.

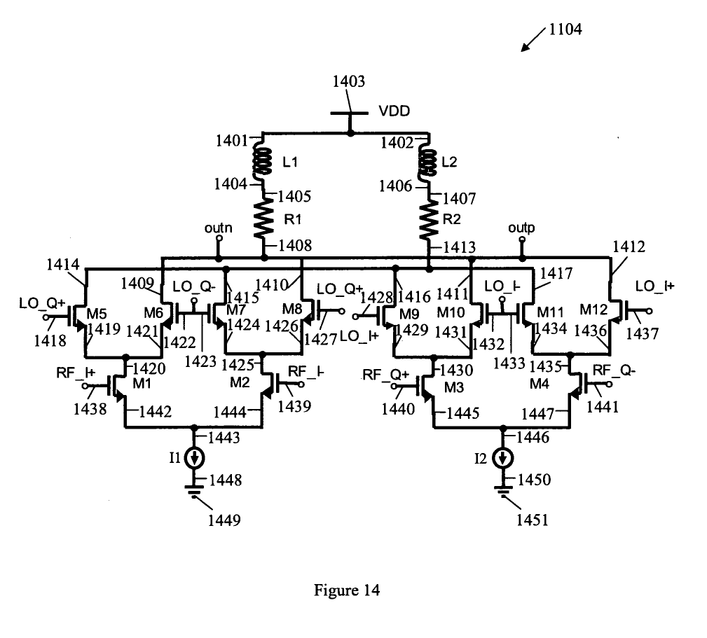

FIG. 14 shows a schematic diagram of the frequency doubler 1104 of the QVCO 1026 according to an embodiment. The frequency doubler 1104 can be a Gilbert cell mixer with inductive loading for higher gain. The input of frequency doubler 1104 may be I and Q signals. The I signal can be multiplied with Q signal to get double frequency using the principle of sin ωt×cos ωt=½ sin (2ωt). The frequency doubler 1104 may be a differential inverter buffer. The inverter may be self-biased by connecting a resistor between an output and an input. The resistor value must be large enough to prevent leakage signal from the input to the output.

The frequency doubler 1104 may have two inductors L1 and L2, two resistors R1 and R2, twelve transistors M1 to M12, and two current sources I1 and I2. A first terminal 1401 of inductor L1 and a first terminal 1402 of inductor L2 may be coupled to a supply voltage 1403. A second terminal 1404 of inductor L1 may be coupled to a first terminal 1405 of resistor R1 and a second terminal 1406 of inductor L2 may be coupled to a first terminal 1407 of resistor R2. A second terminal 1408 of resistor R1 may be coupled to a signal outn, a signal outp, a drain terminal 1409 of transistor M6, a drain terminal 1410 of transistor M8, a drain terminal 1411 of transistor M10, and a drain terminal 1412 of transistor M12. A second terminal 1413 of resistor R2 may be coupled to a drain terminal 1414 of transistor M5, a drain terminal 1415 of transistor M7, a drain terminal 1416 of transistor M9, and a drain terminal 1417 of transistor M11.

A gate terminal 1418 of transistor M5 may be coupled to a signal LO_Q+. A source terminal 1419 of transistor M5 may be coupled to a drain terminal 1420 of transistor M1 and a source terminal 1421 of transistor M6. A gate terminal 1422 of transistor M6 may be coupled to a signal LO_Q− and a gate terminal 1423 of transistor M7. A source terminal 1424 of transistor M7 may be coupled to a drain terminal 1425 of transistor M2 and a source terminal 1426 of transistor M8. A gate terminal 1427 of transistor M8 may be coupled to the signal LO_Q+.

A gate terminal 1428 of transistor M9 may be coupled to the signal LO_I+. A source terminal 1429 of transistor M9 may be coupled to a drain terminal 1430 of transistor M3 and a source terminal 1431 of transistor M10. A gate terminal 1432 of transistor M10 may be coupled to a signal LO_I− and a gate terminal 1433 of transistor M11. A source terminal 1434 of transistor M11 may be coupled to a drain terminal 1435 of transistor M4 and a source terminal 1436 of transistor M12. A gate terminal 1437 of transistor M12 may be coupled to the signal LO_I+.

A gate terminal 1438 of transistor M1 may be coupled to a signal RF_I+. A gate terminal 1439 of transistor M2 may be coupled to a signal RF_I−. A gate terminal 1440 of transistor M3 may be coupled to a signal RF_Q+. A gate terminal 1441 of transistor M4 may be coupled to a signal RF_Q−. A source terminal 1442 of transistor M1 may be coupled to an input terminal 1443 of current source I1 and a source terminal 1444 of transistor M2. A source terminal 1445 of transistor M3 may be coupled to an input terminal 1446 of current source I2 and a source terminal 1447 of transistor M4. An output terminal 1448 of current source I1 may be coupled to ground 1449 and an output terminal 1450 of current source I2 may be coupled to ground 1451.

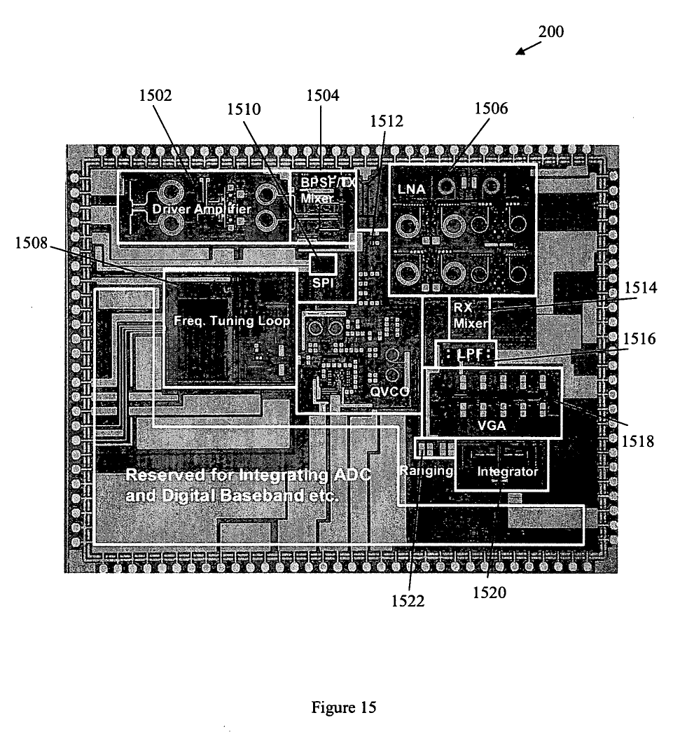

FIG. 15 shows a chip microphotograph of an example communication device 200 (e.g. a UWB transceiver) according to an embodiment. The UWB transmitter and receiver IC chips can be implemented in a Charter's 0.18-μm CMOS technology. The chips may be mounted on a printed circuit board PCB e.g. using QFN48 board and may be tested. The UWB transceiver 1500 may have a driver amplifier 1502, a BPSF and transmitter (TX) mixer 1504, a low noise amplifier (LNA) 1506, a frequency tuning loop 1508, a serial peripheral interface (SPI) 1510, a quadrature voltage-controlled oscillator (QVCO) 1512, a receiver (RX) mixer 1514, a low pass filter (LPF) 1516, a variable gain amplifier (VGA) 1518, an integrator 1520, and a ranging determination circuit 1522. The communication device 200 may also have an analog to digital converter (ADC), and/or a digital baseband and/or other components.

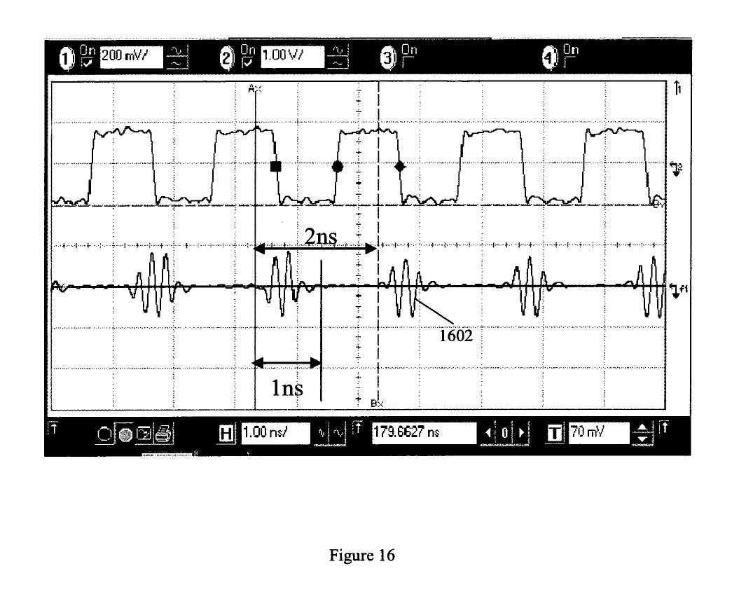

To comply with IEEE 802.15.4a, two requirements should be satisfied. Firstly, a burst of pulses (could be 1-512) with a peak repetition frequency (PRF) of 499.2 MHz may be transmitted within one symbol. FIG. 16 shows a measured pulse sequence 1602 at an output of the transmitter 202 according to an embodiment. The burst of pulses 1602 have a PRF of 499.2 MHz and pulse duration of 1 ns. Therefore, the maximum PRF of the transmitter can be 1 GHz. Transmitted at 1 GHz PRF, the two successive pulses can be differentiated. Secondly, there are 15 channels in 3.1-10.6 GHz. Channel 3 and 9 are mandatory and the others are optional. In one embodiment, the transmitter can cover channels 1-12 and may only be limited by process (0.18 μm CMOS used in this design). The channels 13-15 can be covered if the communication device 200 is implemented in 90 nm CMOS and beyond.

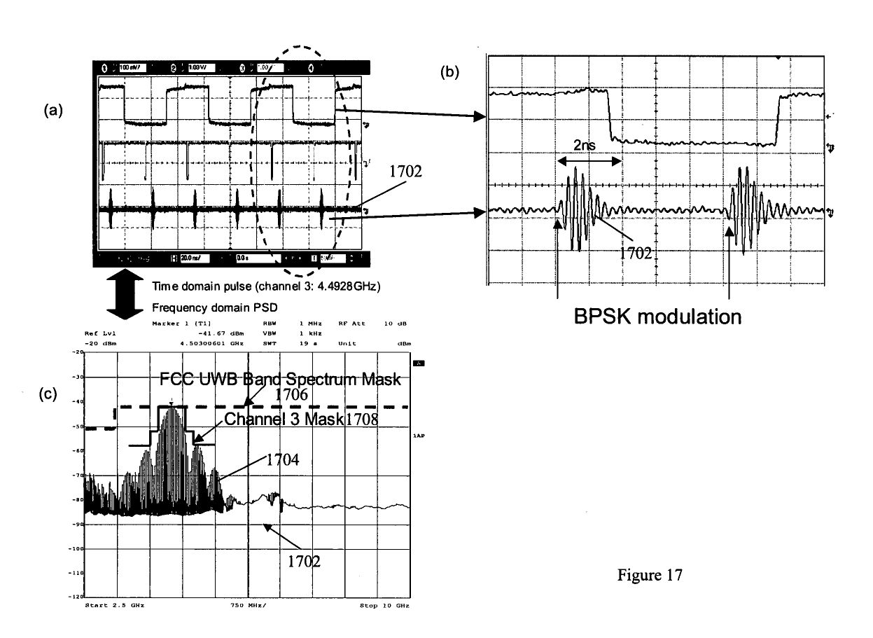

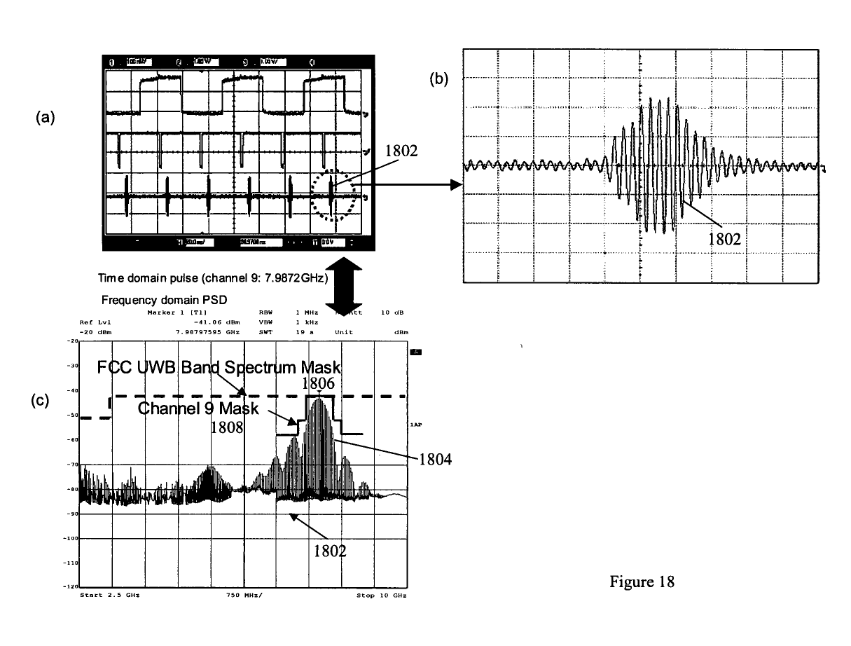

Two measured pulse sequences at the two mandatory channels 3 and 9 and their respective spectrums of the transmitter 202 of an embodiment are shown in FIG. 17 and FIG. 18 respectively. FIG. 17(a) shows a measured pulse sequence 1702 for low band mandatory channel 3 in time domain according to an embodiment. FIG. 17(b) shows an exploded view of the measured pulse sequence 1702 according to an embodiment. The pulse sequence 1702 can be BPSK modulated and controlled by a modulation signal. The generated pulses 1702 are of 2 ns width. The generated pulses 1702 can be of 1.5-2 ns width and can have a maximum swing of 300 mVpp. FIG. 17(c) shows the measured pulse sequence 1702 in frequency domain according to an embodiment. A power spectrum density (PSD) spectrum 1704 of the pulse sequence 1702 can fit both the FCC UWB band mask 1706 and the 802.15.4a channel 3 mask 1708. The peak frequency of the pulse sequence 1702 is 4.4928 GHz. The peaks of wideband second harmonic (centered at 10 GHz) and third harmonic (center at 15 GHz) may be significantly suppressed (>30 dB).

FIG. 18(a) shows a measured pulse sequence 1802 for high band mandatory channel 9 in time domain according to an embodiment. FIG. 18(b) shows an exploded view of the measured pulse sequence 1802 according to an embodiment. FIG. 18(c) shows the measured pulse sequence 1802 in frequency domain according to an embodiment. A PSD spectrum 1804 of the pulse sequence 1702 can fit both the FCC UWB band mask 1806 and the 802.15.4a channel 9 mask 1808. The peak frequency of the pulse sequence 1802 is 7.9872 GHz.

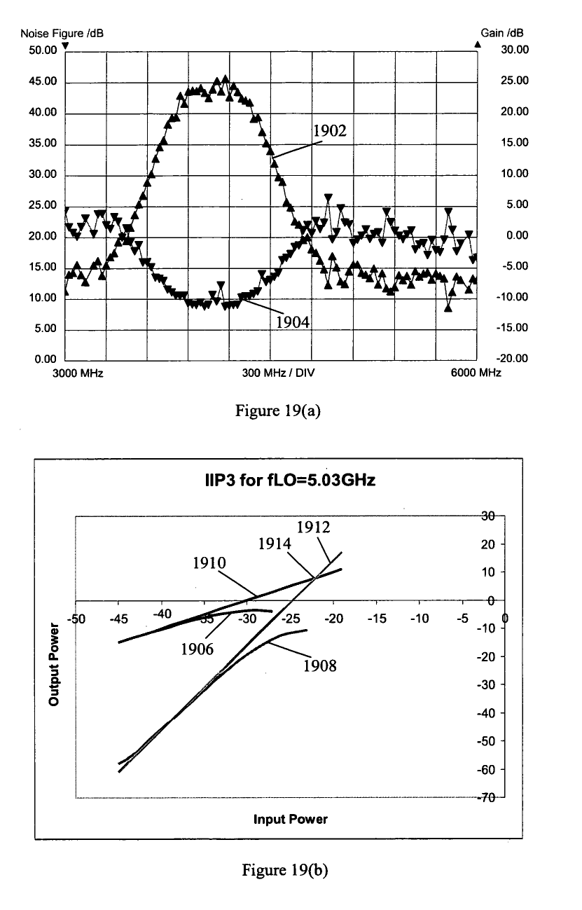

FIG. 19 shows measured RF front-end performance of the receiver 204 at 5 GHz according to an embodiment. FIG. 19(a) shows a graph 1902 of gain plotted against frequency and a graph 1904 of noise figure plotted against frequency according to an embodiment. The overall gain is around 24 dB and the noise figure is 10 dB within channel 4. FIG. 19(b) shows two graphs 1906, 1908 of output power plotted against input power according to an embodiment. The curve 1906 is extended with a straight line 1910 and the curve 1908 is extended with a straight line 1912. The intercept point 1914 of the two straight lines 1910, 1912 is the measured IIP3. The measured IIP3 is −22 dBm at 5 GHz.

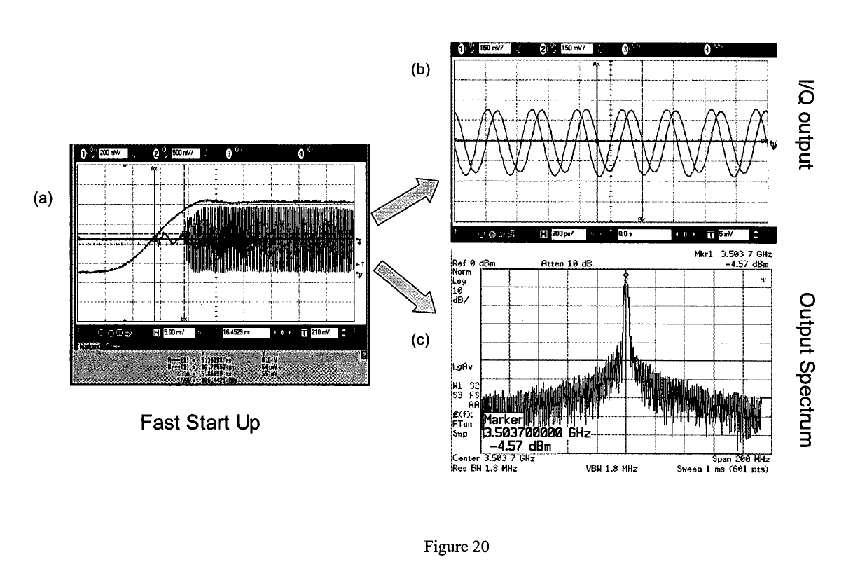

FIG. 20 shows measured performance of the frequency generator 206 according to an embodiment. FIG. 20(a) shows that the VCO has a fast start up time of 5.36 ns according to an embodiment. FIG. 20(b) shows the VCO outputs quadrature I/Q signal at a frequency of 3.5 GHz according to an embodiment. FIG. 20(c) shows an output spectrum of the VCO having a centre frequency of 3.5 GHz according to an embodiment. The performance of the VCO can be beneficial for saving power when there is no data transmission.

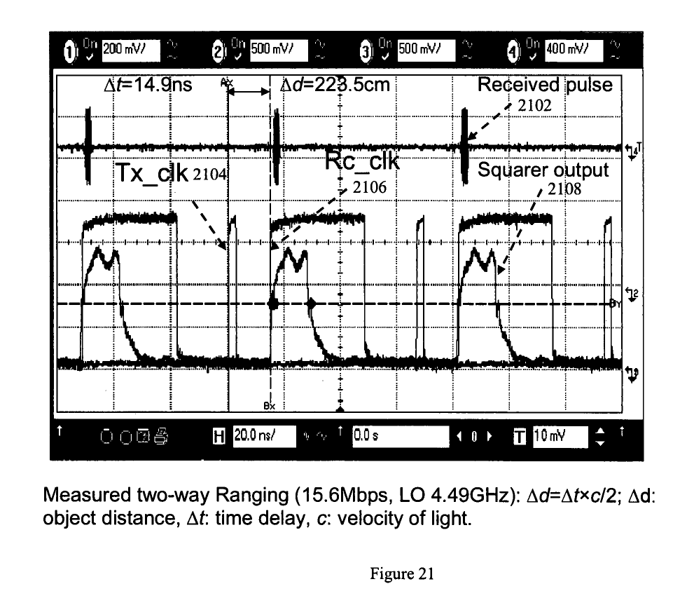

FIG. 21 shows a received pulse 2102, a transmitter clock (Tx_clk) 2104, a receiver clock (Rx_clk) 2106 and a squarer output 2108 according to an embodiment. A measured ranging result can be determined at a pulse repetition frequency (PRF) of 15.6 Mbps and a local oscillation (LO) of 4.49 GHz. The measured time delay between Tx_clk 2104 and Rx_clk 2106 is 14.9 ns. Using the equation Δd=Δt×c/2 (Δd: object distance, Δt: time delay, c: velocity of light), the calculated ranging distance is 223.5 cm.

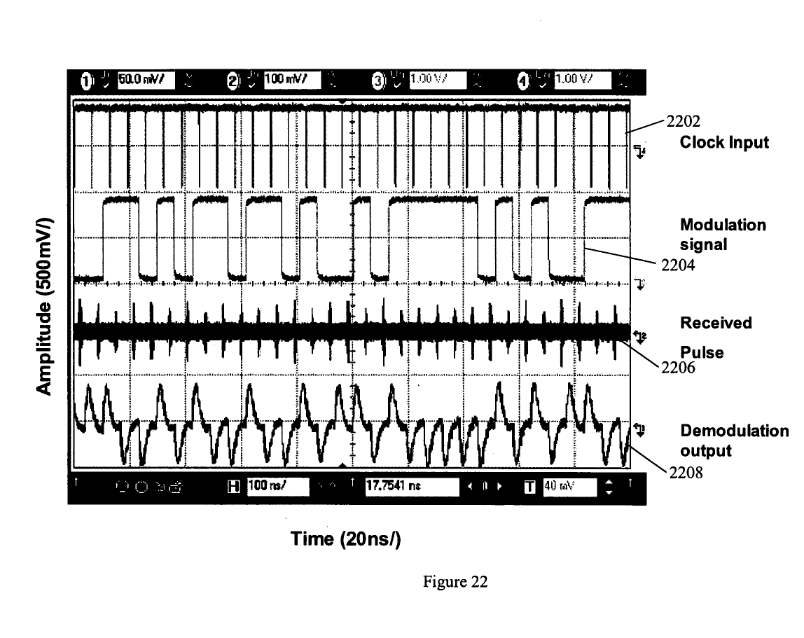

FIG. 22 shows a transmitter clock signal 2202, a transmitted data pattern 2204 (at TX input), a received pulse pattern 2206 (at RX input), and a demodulated data pattern 2208 (at Integrator output) according to an embodiment. In this embodiment, the BPSK pulse transmission and demodulation is performed at PRF of 31.2 MHz and local oscillation (LO) of 4.49 GHz.

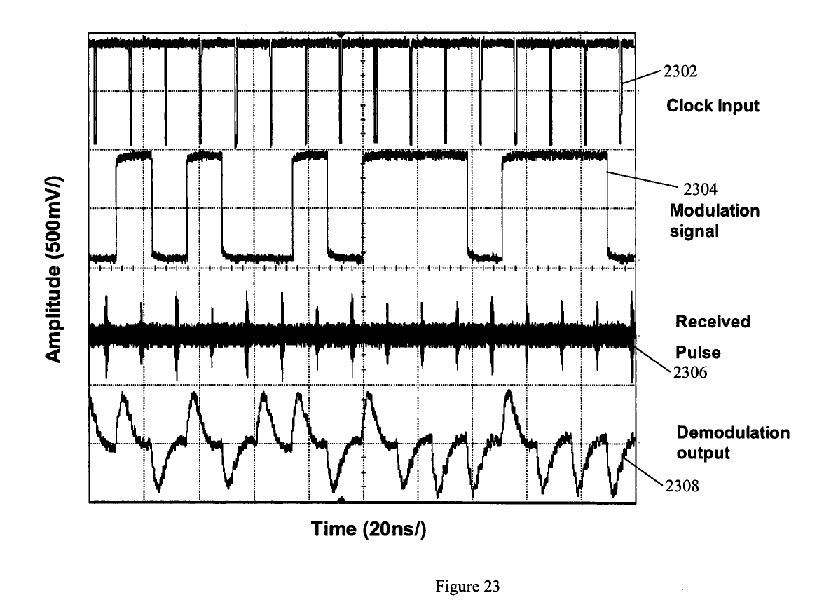

FIG. 23 shows a transmitter clock signal 2302, a transmitted data pattern 2304 (at TX input), a received pulse pattern 2306 (at RX input), and a demodulated data pattern 2308 (at Integrator output) according to an embodiment. In this embodiment, the BPSK pulse transmission and demodulation is performed at PRF of 31.2 MHz and local oscillation (LO) of 7.98 GHz.

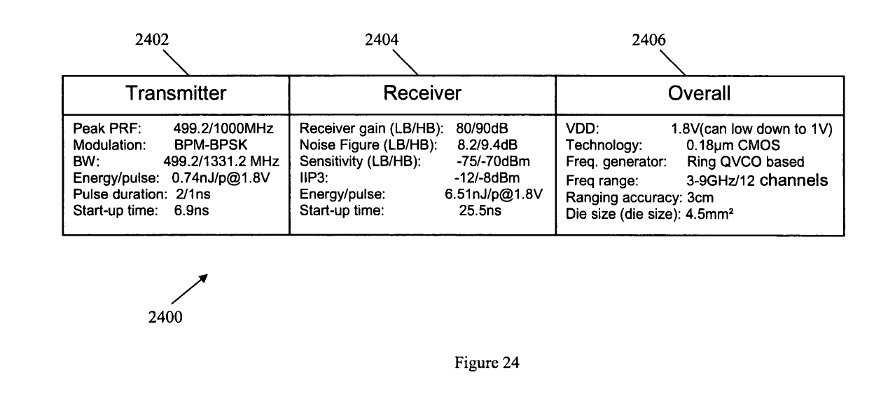

FIG. 24 shows a table 2400 listing the performance of the communication device 200 according to an embodiment. Column 2402 shows the performance of the transmitter 202. Column 2404 shows the performance of the receiver 204. Column 2406 shows the overall performance of the communication device 200. Targeting a low cost and high energy efficiency implementation, the communication device 200 can achieve 0.74 nJ/pulse for transmitter TX and 6.5 nJ/pulse for receiver RX while occupying 4.5 mm² only.

The communication device 200 as described above can be a fully integrated CMOS UWB transceiver IC compatible to IEEE 802.1.5.4a. With the architecture of the communication device 200, both the low power communication and localization can be achieved concurrently. The analog baseband pulse shaping and carrier based upconversion can be adopted to make the UWB pulse fit both into FCC band mask and channel mask. A multi-tone frequency synthesizer (e.g. a two-inductor, 12-band UWB frequency synthesizer) may be used to generate multitone carrier frequency and the switching of carrier makes it flexible for multichannel (e.g. up to 12) transmission in the design. A tunable RF front end may be used to tune to the respective channel in the receiver 204. A tunable narrowband LNA/Mixer over 3-9 GHz band can be used. A BPSK demodulation and two way ranging can be realized. The transmitter 202 and receiver 204 of the communication device 200 can consume only 0.74 nJ/b and 6.5 nJ/b at 1.8V supply with a scalable data rate up to 1 G pulse/s. The ranging accuracy attained may be 3 cm.

Further, the communication device 200 can use pulse synchronized demodulation to achieve precision localization, a pulse generation circuit to enable high spatial resolution, a preamble based localization circuit technique, a quadrature fine tuning loop for frequency synthesizer, and a proprietary BPPM circuit for power saving.

The communication device 200 can achieve concurrent communication and localization by implementing a preamble-defined integrated function and a unique ‘node’ platform for wireless sensor network. For power savings, the communication device 200 can use a burst mode power control and reduction and a system level optimization of low power consumption.

The communication device 200 can use new circuits for BPM-BPSK modulation and circuits of multi-user capability and interference resistance. The communication device 200 can also use a simplified base-band analog implementation to achieve low power and cost effectiveness.

The communication device 200 can be used in various applications such as video/audio streaming, wireless sensor network, wireless personnel area network, healthcare application, etc.

It has become apparent, in an embodiment, a complete UWB transceiver IC which is 802.15.4a compliant and supports both communication and localization, is provided.

According to an embodiment, a communication device includes a transmitter path, including: a transmitter clock generating circuit configured to generate a transmitter clock signal; a receiver path, including: a clock recovery circuit configured to recover a receiver clock signal from a received signal; a comparator circuit coupled to the clock recovery circuit and configured to compare the receiver clock signal and the transmitter clock signal to generate an output signal; a ranging determination circuit configured to determine a ranging value based on the output signal.

According to an embodiment, the transmitter path further includes a pulse shaper to tunably shape the pulse of a transmitter clock signal.

According to an embodiment, the transmitter path further includes a modulator coupled to the pulse shaper to modulate a transmitter signal to be transmitted into one of a plurality of predefined frequency ranges, triggered by the shaped transmitter clock signal.

According to an embodiment, the transmitter path further includes a mixer to provide an up-converted signal to be transmitted, wherein the mixer is coupled to the modulator to receive the modulated signal to be transmitted.

According to an embodiment, the transmitter path further includes at least one amplifier to amplify the up-converted signal to be transmitted.

According to an embodiment, the receiver path further includes at least one amplifier to amplify the received signal.

According to an embodiment, the amplifier is a low noise amplifier.

According to an embodiment, the receiver path further includes an in-phase mixer to provide an in-phase amplified signal; and a quadrature mixer to provide a quadrature amplified signal.

According to an embodiment, the receiver path further includes an in-phase filter to filter the in-phase amplified signal provided by the in-phase mixer and a quadrature filter to filter the quadrature amplified signal provided by the quadrature mixer.

According to an embodiment, the in-phase filter is a low pass filter.

According to an embodiment, the quadrature filter is a low pass filter.

According to an embodiment, the receiver path further includes: an in-phase variable gain amplifier to amplify the filtered in-phase signal; and a quadrature variable gain amplifier to amplify the filtered quadrature signal.

According to an embodiment, the receiver path further includes: an in-phase integration circuit coupled to an output of the in-phase variable gain amplifier to receive the amplified filtered in-phase signal and to produce an analog integrated in-phase signal; and a quadrature integration circuit coupled to an output of the quadrature variable gain amplifier to receive the amplified filtered quadrature signal and to produce an analog integrated quadrature signal.

According to an embodiment, the receiver path further includes: an in-phase analog-to-digital converter to convert the analog integrated in-phase signal provided by the in-phase integration circuit to a digital integrated in-phase signal; and a quadrature analog-to-digital converter to convert the analog integrated quadrature signal provided by the quadrature integration circuit to a digital integrated quadrature signal.

According to an embodiment, the clock recovery circuit is coupled to an output of the in-phase variable gain amplifier to receive the amplified filtered in-phase signal and to an output of the quadrature variable gain amplifier to receive the amplified filtered quadrature signal.

According to an embodiment, the clock recovery circuit includes a first squaring circuit to produce a first squared output and a second squaring circuit to produce a second squared output.

According to an embodiment, the clock recovery circuit further includes a summing circuit to combine the first squared output and the second squared output to form a summed output.

According to an embodiment, the clock recovery circuit further includes a first low pass filter to filter the summed output provided by the summing circuit to recover the receiver clock signal.

According to an embodiment, the comparator circuit includes an edge detector to compare the receiver clock signal and the transmitter clock signal to generate an output pulse signal.

According to an embodiment, the comparator circuit further includes a second low pass filter to filter the output pulse signal provided by the edge detector to produce an analog output signal.

According to an embodiment, the receiver path further includes a first analog-to-digital converter to convert the analog output signal provided by the second low pass filter to a digital output signal.

According to an embodiment, the first analog-to-digital converter is coupled between the second low pass filter and the ranging determination circuit.

According to an embodiment, the communication device further includes a frequency generator to provide oscillator signals.

According to an embodiment, the frequency generator is coupled to the mixer to provide a transmitter oscillator signal to the mixer.

According to an embodiment, the frequency generator is coupled to the in-phase mixer to provide an in-phase receiver oscillator signal to the in-phase mixer; and the frequency generator is coupled to the quadrature mixer to provide a quadrature receiver oscillator signal to the quadrature mixer.

According to an embodiment, the frequency generator further includes a voltage control oscillator configured to generate at least one oscillator output signal.

According to an embodiment, the frequency generator further includes a first buffer circuit and a second buffer circuit coupled to the voltage control oscillator to buffer the at least one oscillator output signal.

According to an embodiment, the frequency generator further includes a coarse tuning circuit coupled to the first buffer circuit to provide coarse tuning of the frequency to the voltage control oscillator.

According to an embodiment, the frequency generator further includes a fine tuning circuit coupled to the coarse tuning circuit to provide fine tuning of the frequency to the voltage control oscillator.

According to an embodiment, the first buffer circuit is coupled to the mixer to provide the transmitter oscillator signal to the mixer.

According to an embodiment, the second buffer circuit is coupled to the in-phase mixer to provide the in-phase receiver oscillator signal to the in-phase mixer; wherein the second buffer circuit is coupled to the quadrature mixer to provide the quadrature receiver oscillator signal to the quadrature mixer.

According to an embodiment, the predefined frequency ranges are in the range of about 200 MHz to about 11 GHz.

According to an embodiment, a method of determining a ranging value in a communication device includes: generating a transmitter clock signal; recovering a receiver clock signal from a received signal; comparing the receiver clock signal and the transmitter clock signal to generate an output signal; and determining the ranging value based on the output signal.

According to an embodiment, a communication device includes: a clock recovery circuit configured to recover a receiver clock signal from a received radio preamble signal including a preamble code; a ranging determination circuit configured to determine a ranging value based on the preamble signal.

While embodiments of the invention have been particularly shown and described with reference to specific embodiments, it should be understood by those skilled in the art that various changes in form and detail may be made therein without departing from the spirit and scope of the invention as defined by the appended claims.

The scope of the invention is thus indicated by the appended claims and all changes which come within the meaning and range of equivalency of the claims are therefore intended to be embraced.

What is claimed is:

1. A communication device, comprising:
a transmitter path, comprising:
a transmitter clock generating circuit configured to generate a transmitter clock signal;
a receiver path, comprising:
a clock recovery circuit configured to recover a receiver clock signal from a received signal;
a comparator circuit coupled to the clock recovery circuit and configured to compare the receiver clock signal and the transmitter clock signal to generate an output signal;
a ranging determination circuit configured to determine a ranging value based on the output signal.

2. The communication device of claim 1,
wherein the transmitter path further comprises a pulse shaper to tunably shape the pulse of a transmitter clock signal.

3. The communication device of claim 2,
wherein the transmitter path further comprises a modulator coupled to the pulse shaper to modulate a transmitter signal to be transmitted into one of a plurality of predefined frequency ranges, triggered by the shaped transmitter clock signal.

4. The communication device of claim 3,
wherein the transmitter path further comprises a mixer to provide an up-converted signal to be transmitted, wherein the mixer is coupled to the modulator to receive the modulated signal to be transmitted.

5. The communication device of claim 4,
wherein the transmitter path further comprises at least one amplifier to amplify the up-converted signal to be transmitted.

6. The communication device of claim 5,
wherein the receiver path further comprises at least one amplifier to amplify the received signal.

7. The communication device of claim 6,
wherein the amplifier is a low noise amplifier.

8. The communication device of claim 6,
wherein the receiver path further comprises:
an in-phase mixer to provide an in-phase amplified signal;
a quadrature mixer to provide a quadrature amplified signal.

9. The communication device of claim 8,
wherein the receiver path further comprises an in-phase filter to filter the in-phase amplified signal provided by the in-phase mixer and a quadrature filter to filter the quadrature amplified signal provided by the quadrature mixer.

10. The communication device of claim 9,
wherein the in-phase filter is a low pass filter.

11. The communication device of claim 9,
wherein the quadrature filter is a low pass filter.

12. The communication device of claim 9,
wherein the receiver path further comprises:
an in-phase variable gain amplifier to amplify the filtered in-phase signal;
a quadrature variable gain amplifier to amplify the filtered quadrature signal.

13. The communication device of claim 12,
wherein the receiver path further comprises:
an in-phase integration circuit coupled to an output of the in-phase variable gain amplifier to receive the amplified filtered in-phase signal and to produce an analog integrated in-phase signal;
a quadrature integration circuit coupled to an output of the quadrature variable gain amplifier to receive the amplified filtered quadrature signal and to produce an analog integrated quadrature signal.

14. The communication device of claim 13,
wherein the receiver path further comprises:
an in-phase analog-to-digital converter to convert the analog integrated in-phase signal provided by the in-phase integration circuit to a digital integrated in-phase signal;
a quadrature analog-to-digital converter to convert the analog integrated quadrature signal provided by the quadrature integration circuit to a digital integrated quadrature signal.

15. The communication device of claim 12,
wherein the clock recovery circuit is coupled to an output of the in-phase variable gain amplifier to receive the amplified filtered in-phase signal and to an output of the quadrature variable gain amplifier to receive the amplified filtered quadrature signal.

16. The communication device of claim 15,
wherein the clock recovery circuit comprises a first squaring circuit to produce a first squared output and a second squaring circuit to produce a second squared output.

17. The communication device of claim 16,
wherein the clock recovery circuit further comprises a summing circuit to combine the first squared output and the second squared output to form a summed output.

18. The communication device of claim 17,
wherein the clock recovery circuit further comprises a first low pass filter to filter the summed output provided by the summing circuit to recover the receiver clock signal.

19. The communication device of claim 18,
wherein the comparator circuit comprises an edge detector to compare the receiver clock signal and the transmitter clock signal to generate an output pulse signal.

20. The communication device of claim 19,
wherein the comparator circuit further comprises a second low pass filter to filter the output pulse signal provided by the edge detector to produce an analog output signal.

21. The communication device of claim 20,
wherein the receiver path further comprises:
a first analog-to-digital converter to convert the analog output signal provided by the second low pass filter to a digital output signal.

22. The communication device of claim 21,
wherein the first analog-to-digital converter is coupled between the second low pass filter and the ranging determination circuit.

23. The communication device of claim 8, further comprising:
a frequency generator to provide oscillator signals.

24. The communication device of claim 23,
wherein the frequency generator is coupled to the mixer to provide a transmitter oscillator signal to the mixer.

25. The communication device of claim 24,
wherein the frequency generator is coupled to the in-phase mixer to provide an in-phase receiver oscillator signal to the in-phase mixer;
wherein the frequency generator is coupled to the quadrature mixer to provide a quadrature receiver oscillator signal to the quadrature mixer.

26. The communication device of claim 25,
wherein the frequency generator further comprises:
a voltage control oscillator configured to generate at least one oscillator output signal.

27. The communication device of claim 26,
wherein the frequency generator further comprises a first buffer circuit and a second buffer circuit coupled to the voltage control oscillator to buffer the at least one oscillator output signal.

28. The communication device of claim 27,
wherein the frequency generator further comprises a coarse tuning circuit coupled to the first buffer circuit to provide coarse tuning of the frequency to the voltage control oscillator.

29. The communication device of claim 28,
wherein the frequency generator further comprises a fine tuning circuit coupled to the coarse tuning circuit to provide fine tuning of the frequency to the voltage control oscillator.

30. The communication device of claim 29,
wherein the first buffer circuit is coupled to the mixer to provide the transmitter oscillator signal to the mixer.

31. The communication device of claim 29,
wherein the second buffer circuit is coupled to the in-phase mixer to provide the in-phase receiver oscillator signal to the in-phase mixer;
wherein the second buffer circuit is coupled to the quadrature mixer to provide the quadrature receiver oscillator signal to the quadrature mixer.

32. The communication device of claim 3,
wherein the predefined frequency ranges are in the range of about 200 MHz to about 11 GHz.

33. A method of determining a ranging value in a communication device, the method comprising:
generating a transmitter clock signal;
recovering a receiver clock signal from a received signal;
comparing the receiver clock signal and the transmitter clock signal to generate an output signal; and
determining the ranging value based on the output signal.

34. A communication device, comprising:
a clock recovery circuit configured to recover a receiver clock signal from a received radio preamble signal comprising a preamble code;
a ranging determination circuit configured to determine a ranging value based on the preamble signal.
